(19) United States
(12) Patent Application Publication
(10) Pub. No.: US 2008/0083027 A1
(43) Pub. Date: Apr. 3, 2008

(54) Document Editing Environment that Varies Based Upon Security Level of User Who Performs the Editing

(75) Inventors: Daniel J. Freiman, Philadelphia, PA (US); Jeremy C. Herr, Elkins Park, PA (US); Mark A. Weiss, Rydal, PA (US); Christopher M. Frey, Willow Grove, PA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: COLORQUICK, L.L.C., Pennsauken, NJ (US)

(21) Appl. No.: 11/863,719

(22) Filed: Sep. 28, 2007

Related U.S. Application Data
(60) Provisional application No. 60/848,463, filed on Sep. 29, 2006.

(51) Int. Cl. G06F 7/04

(52) U.S. Cl. 726/16

(57) ABSTRACT

A document editing environment is provided that varies based on the type of user. One of a plurality of different types of security levels are assigned to different users who edit documents. A document editing environment is defined for a plurality of different types of documents based at least upon the security level assigned to a user who edits the document. The defined document editing environment is then provided to the user for use in editing a document.

### CROSS-REFERENCE TO RELATED APPLICATIONS

This application claims the benefit of U.S. Provisional Patent Application No. 60/848,463 filed Sep. 29, 2006.

This application relates to U.S. Application No. 11/______ filed ______ entitled “Graphical object insertion during preparation of production data for a print job using a still image proxy of a page description language image file” (Attorney Docket No. 10379-24US).

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

U.S. Pat. No. 6,839,149 (Herr) discloses a method of preparing production data for a print job, wherein the production data includes an electronic document defined by a page description language (PDL) and the electronic document is stored in a PDL image file. The method operates as follows:

(1) A still image proxy is created of the PDL image file.

(2) An image display of the still image proxy is electronically manipulated and information about the manipulations is recorded.

(3) The information about the manipulations is used to revise the PDL image file so as to match the PDL image file to the manipulations made to the image display of the still image proxy.

It would be desirable to extend the capabilities of this method to allow graphical objects to be inserted into the image display of the still image proxy and to revise the PDL image file in accordance with the properties of the inserted graphical objects. It would also be desirable to provide a security model for document editing that provides a document editing environment that varies for each document based upon the security level of a user. The present invention fulfills such needs.

### BRIEF DESCRIPTION OF THE DRAWINGS

The foregoing summary as well as the following detailed description of preferred embodiments of the invention, will be better understood when read in conjunction with the appended drawings. For the purpose of illustrating the invention, the drawings show presently preferred embodiments. However, the invention is not limited to the precise arrangements and instrumentalities shown. In the drawings:

FIGS. 1-44 are user interface display screens in accordance with preferred embodiments of the present invention.

FIGS. 46-51 are flowcharts in accordance with preferred embodiments of the present invention.

### BRIEF SUMMARY OF THE INVENTION

A document editing environment is provided that varies based on the type of user. One of a plurality of different types of security levels are assigned to different users who edit documents. A document editing environment is defined for a plurality of different types of documents based at least upon the security level assigned to a user who edits the document. The defined document editing environment is then provided to the user for use in editing a document.

### DETAILED DESCRIPTION OF THE INVENTION

Certain terminology is used herein for convenience only and is not to be taken as a limitation on the present invention.

This patent application includes an Appendix having a file named appendix.txt, created on Sep. 26, 2007, and having a size of 446,833 bytes. The Appendix is incorporated by reference into the present patent application.

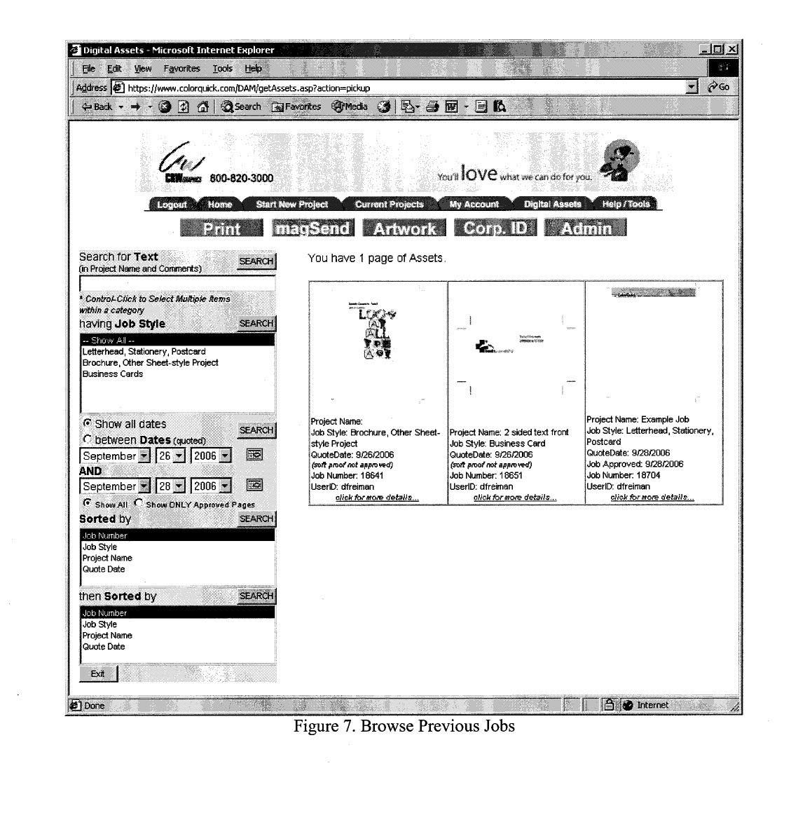

The present invention is described in the context of a web-based commercial implementation called Improv™ marketed by Colorquick, L.L.C, Pennsauken, New Jersey. Improv is a next-generation version of a web-based process called QuickFit® described in U.S. Pat. No. 6,839,149 (Herr), which is incorporated by reference herein. FIG. 7 of U.S. Pat. No. 6,839,149 is a flowchart of the QuickFit process. The steps of FIG. 7 are repeated herein for convenience.

1. Input original PDL-defined image.

2. Create a user interface that includes a still image format proxy of the original PDL-defined image that can be manipulated with respect to a job parameter specific (and dynamically generated) static template.

2. Manipulate the still image proxy with respect to the template, or vice-versa.

3. Append production specifications made to the still image proxy.

4. Record any physical manipulations and/or production specifications made or appended to the still image proxy.

5. Use the recorded physical manipulations and/or production specifications to modify the original PDL-defined image to match the modifications made to the still image proxy.

Improv also performs the same processes as QuickFit, but includes enhanced features, including the following features:

1. Ability to create and insert a graphical object, such as a text box or an image, into the still image proxy. If the graphical object is a text box, a user can input and/or change the contents of the graphical object.

2. Ability to designate different levels of users (security levels) regarding control over the graphical objects. For example, an administrator may have the ability to create text boxes and define the types of manipulations that may be done to them, whereas users only have the ability to edit their content.

Examples of Improv features are illustrated in the following user interface display screens which illustrate the document editing environment presented to a user.

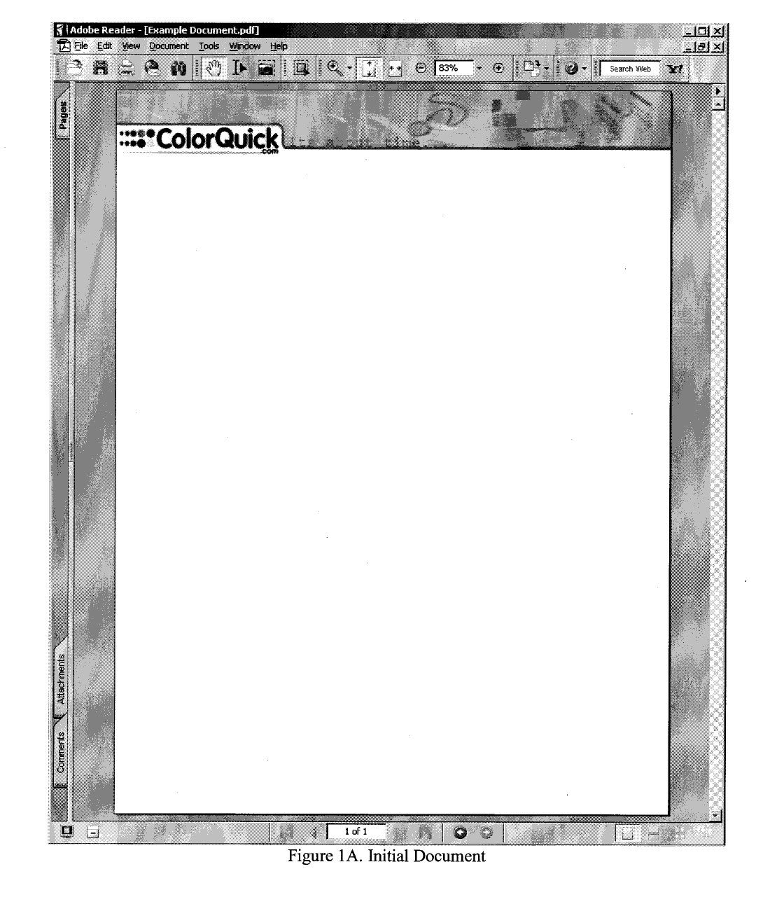

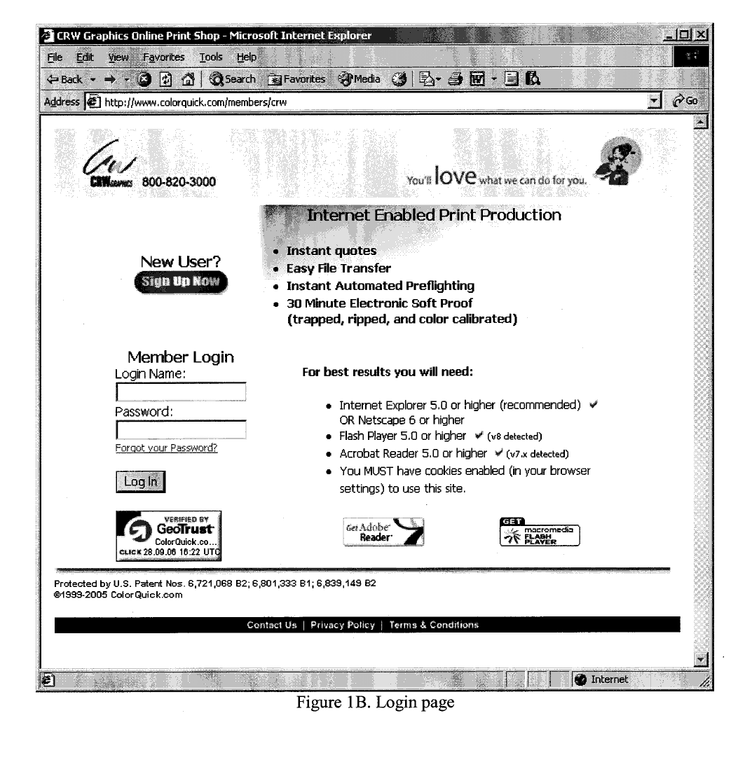

FIG. 1A shows an initial PDF to be altered and Printed.

FIG. 1B shows the user login page.

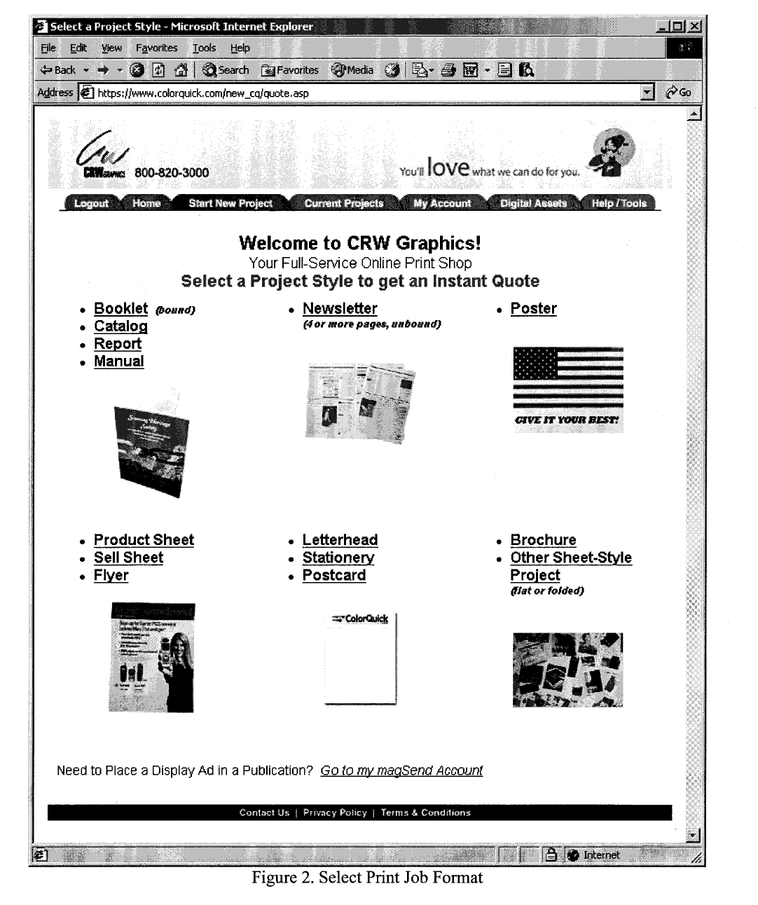

FIG. 2 show the various types of jobs a user selects from.

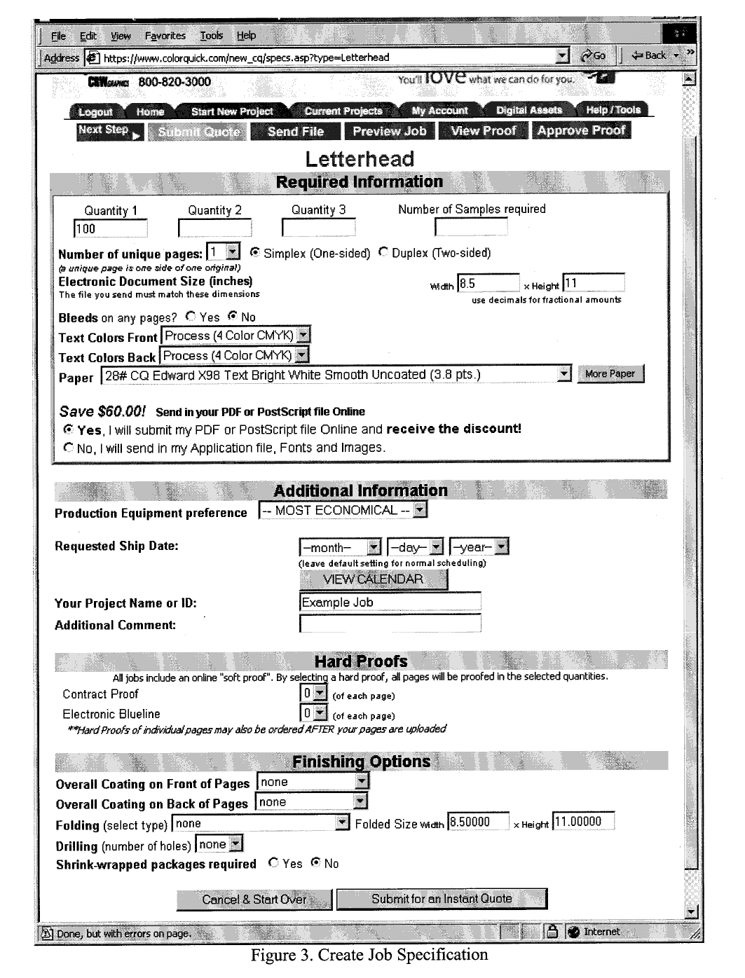

FIG. 3 shows how the user defines the job specification

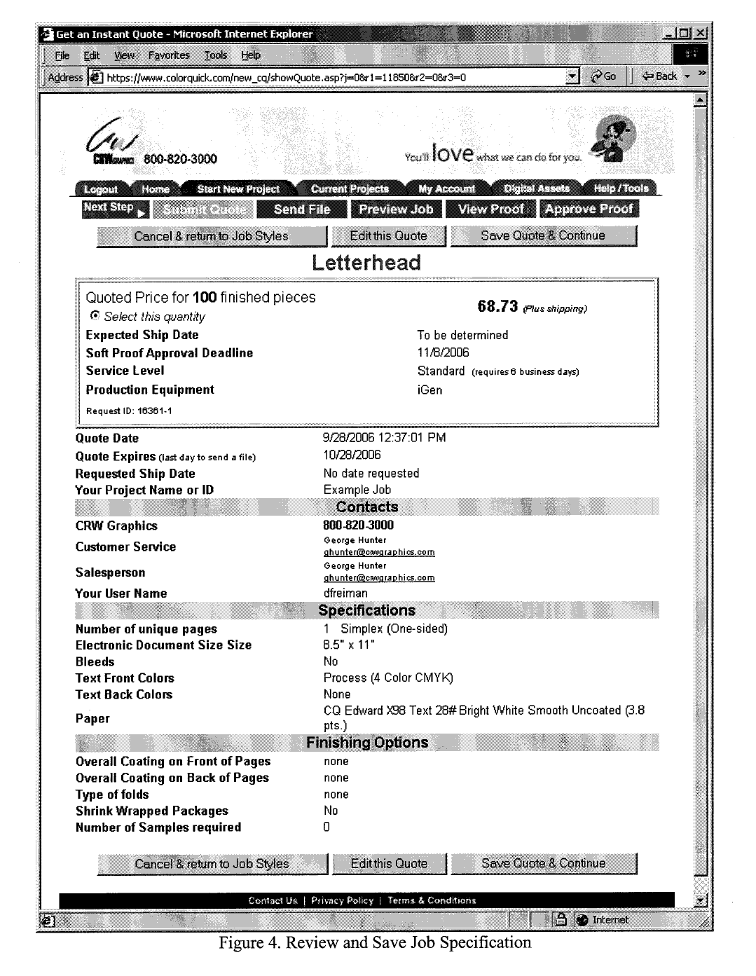

FIG. 4 shows a user reviewing the options that were selected in FIG. 3.

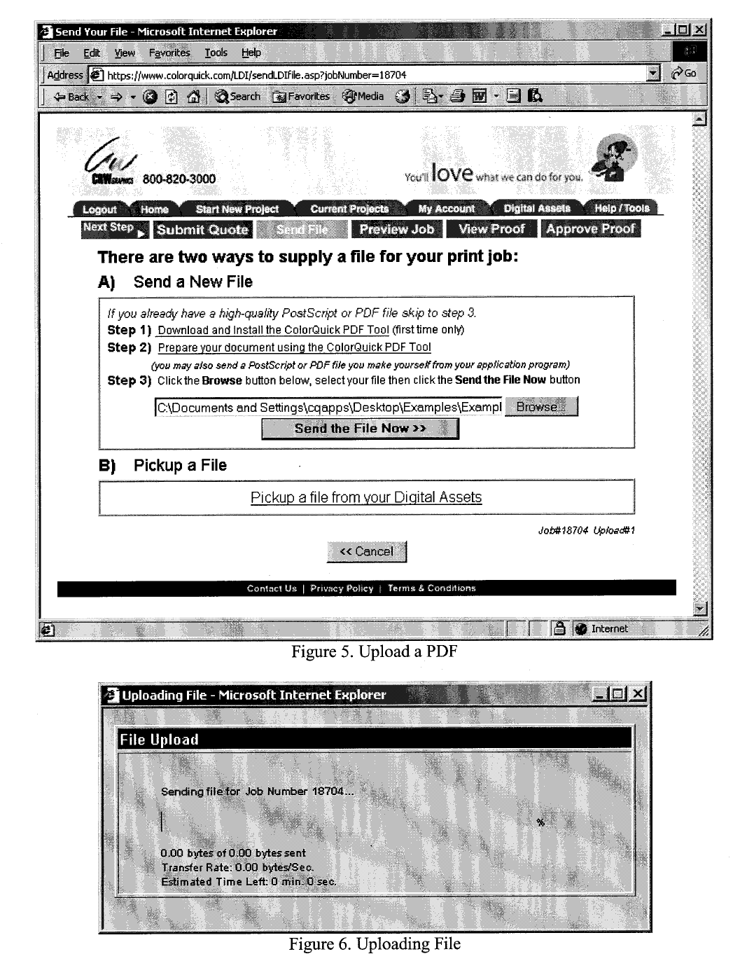

FIGS. 5-6 show a user uploading a PDF file to print in the print job.

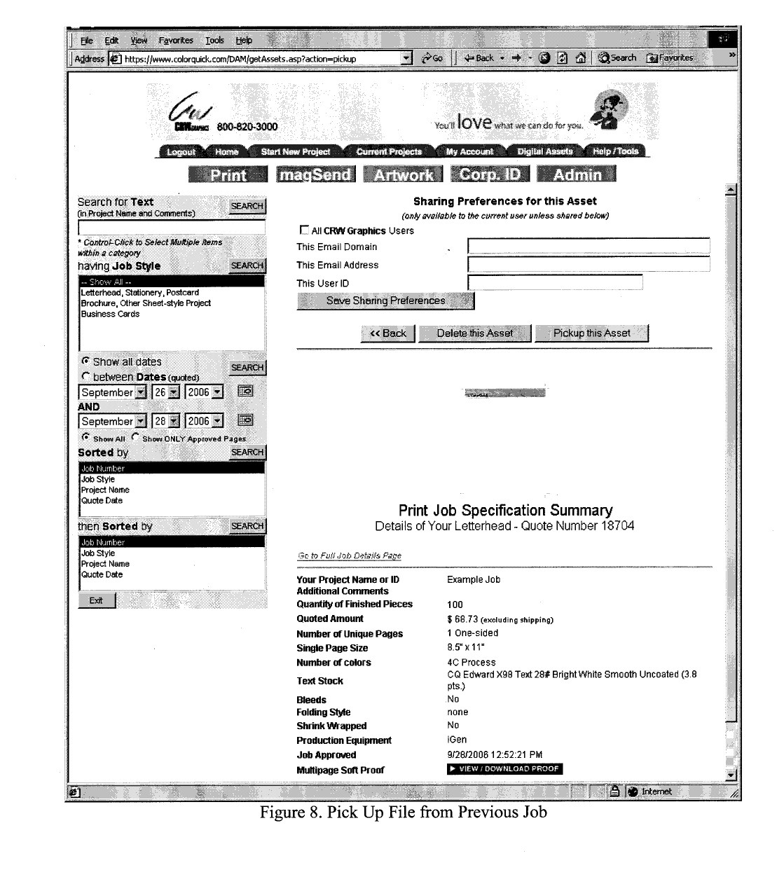

FIGS. 7-8 show a user selecting a PDF file that was previously uploaded to print in the current job.

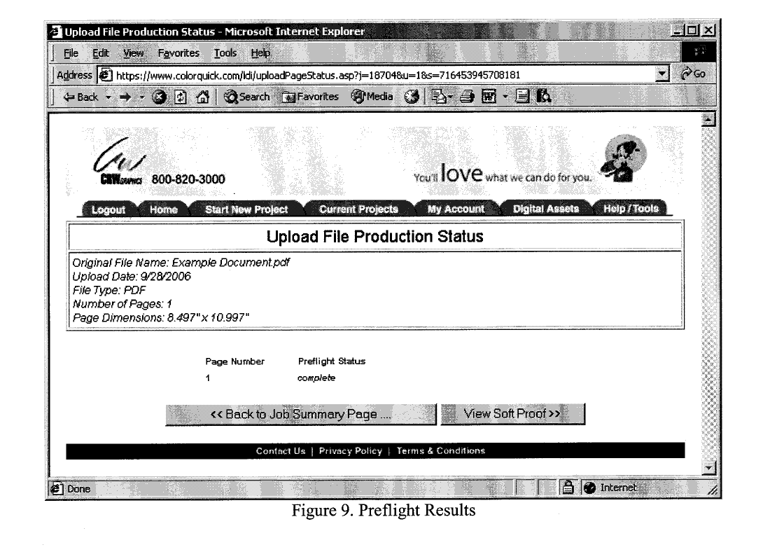

FIG. 9 shows the results of the preflighting of PDF file selected in FIGS. 5-8.

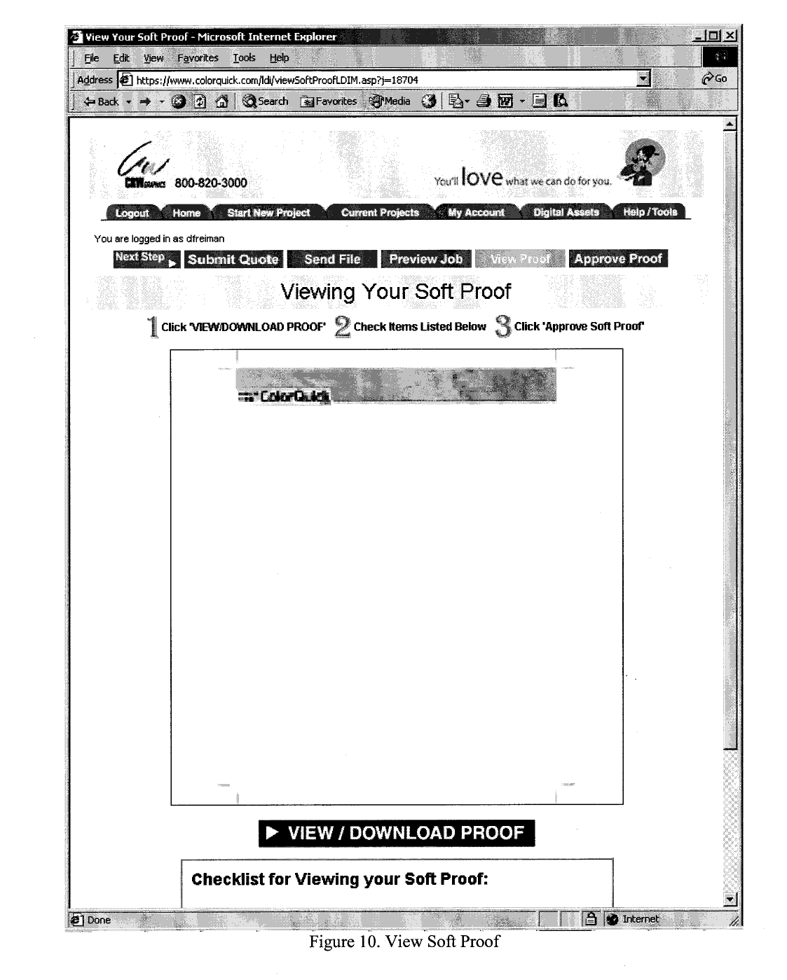

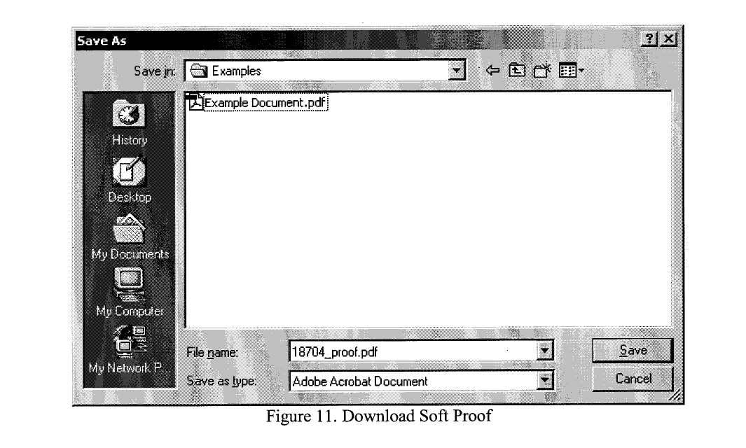

FIGS. 10-11 show a user downloading the soft proof for the current job.

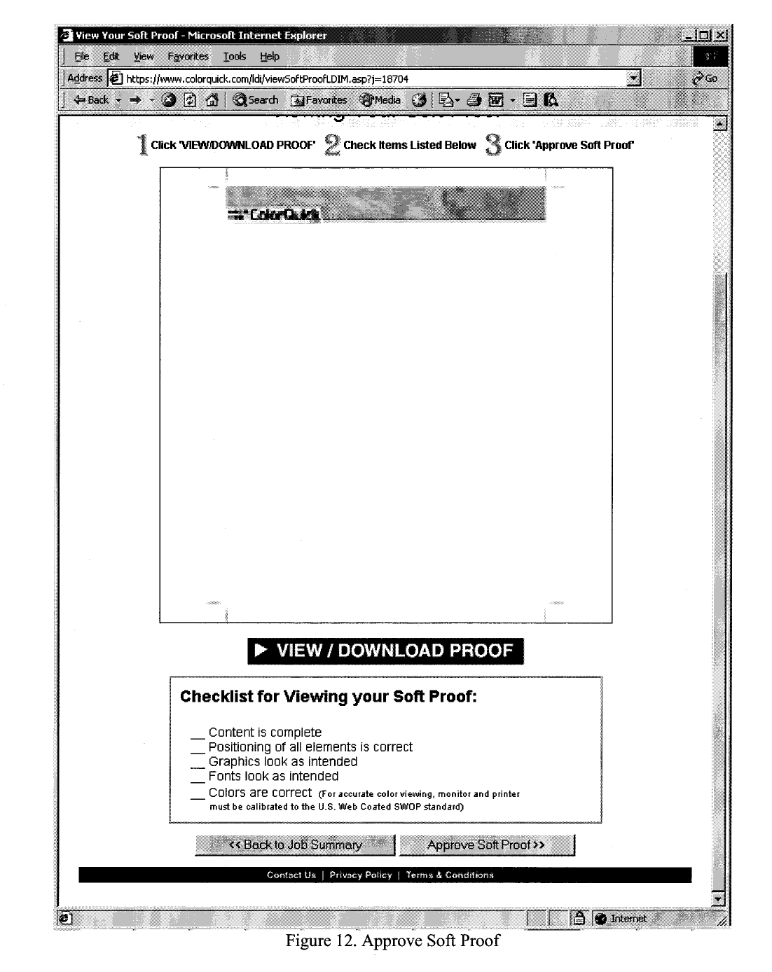

FIG. 12 shows how a user can approve the soft proof for the current job.

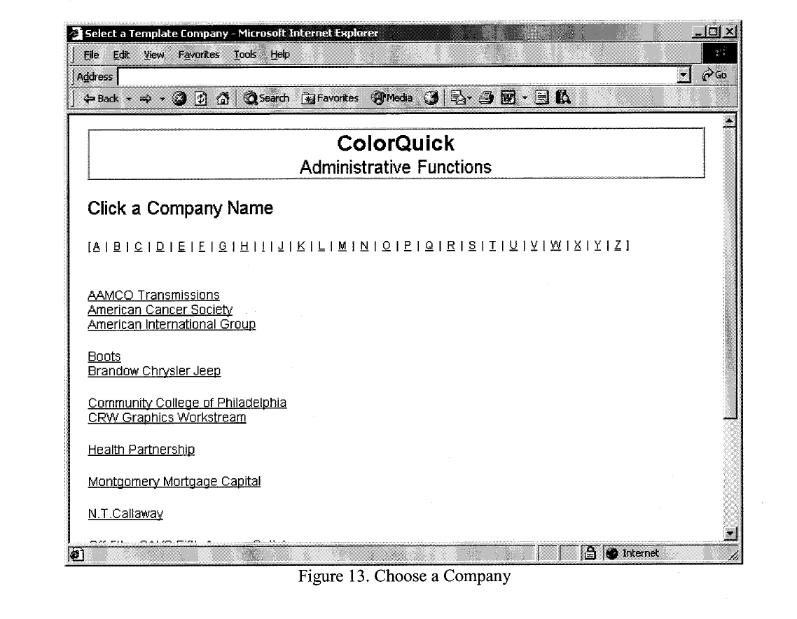

FIG. 13 shows how a user can select a company to create a print job for.

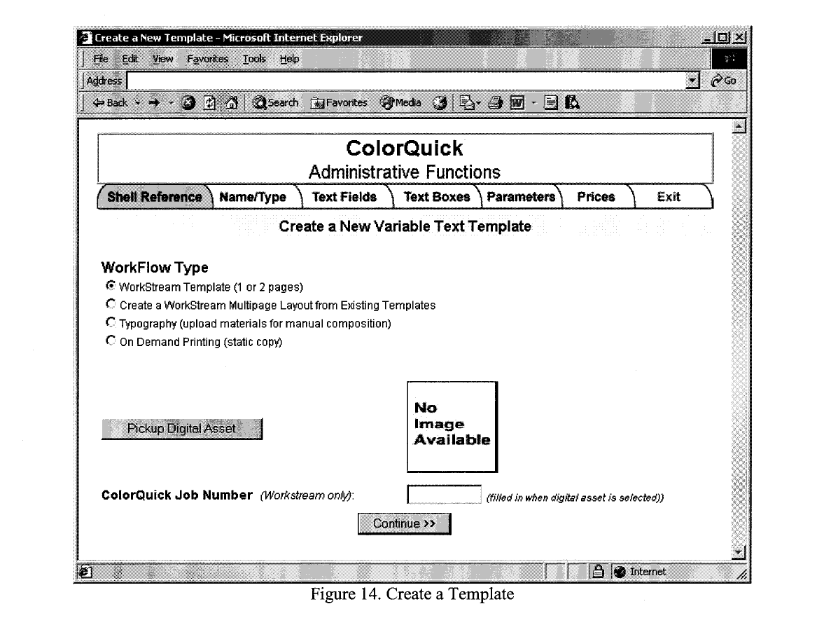

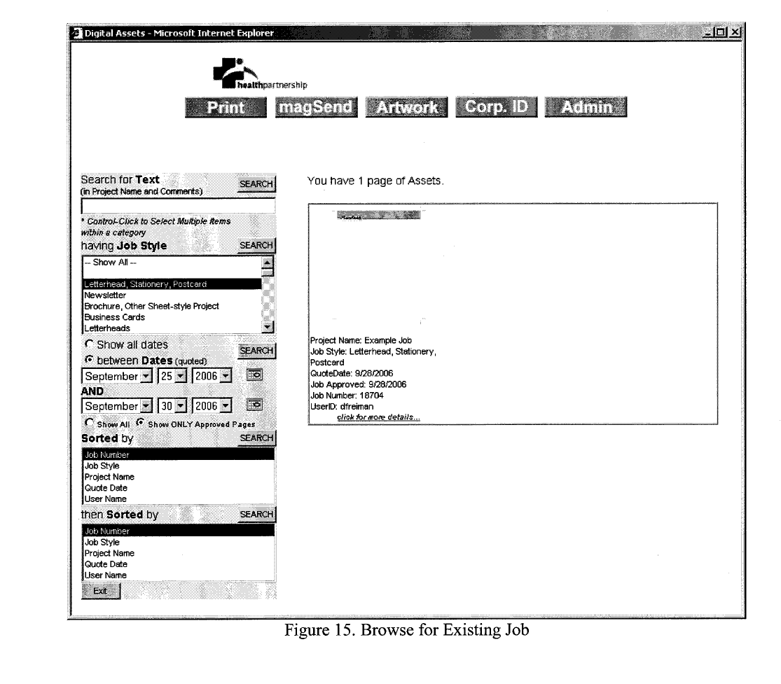

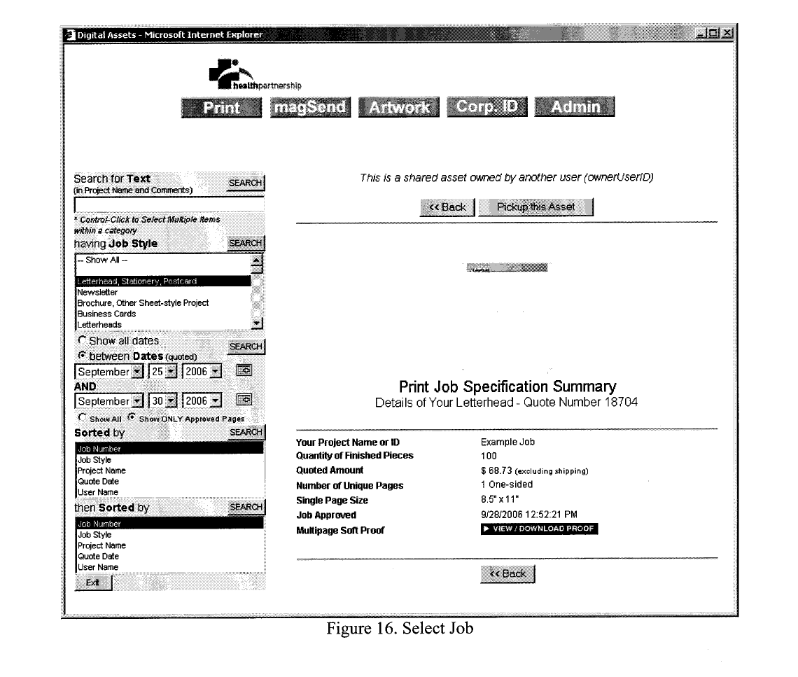

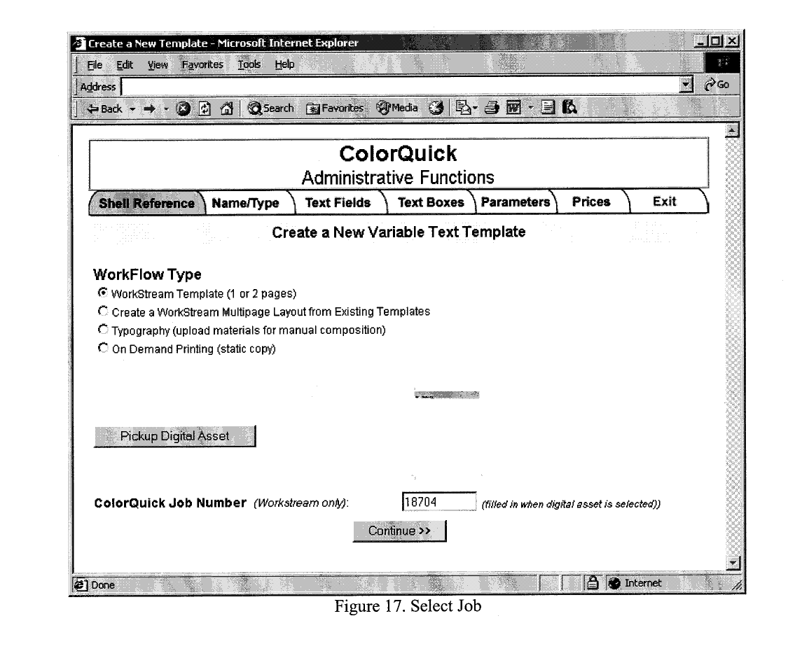

FIGS. 14-17 show the pages a user must browse through to select a job to be transformed into a template.

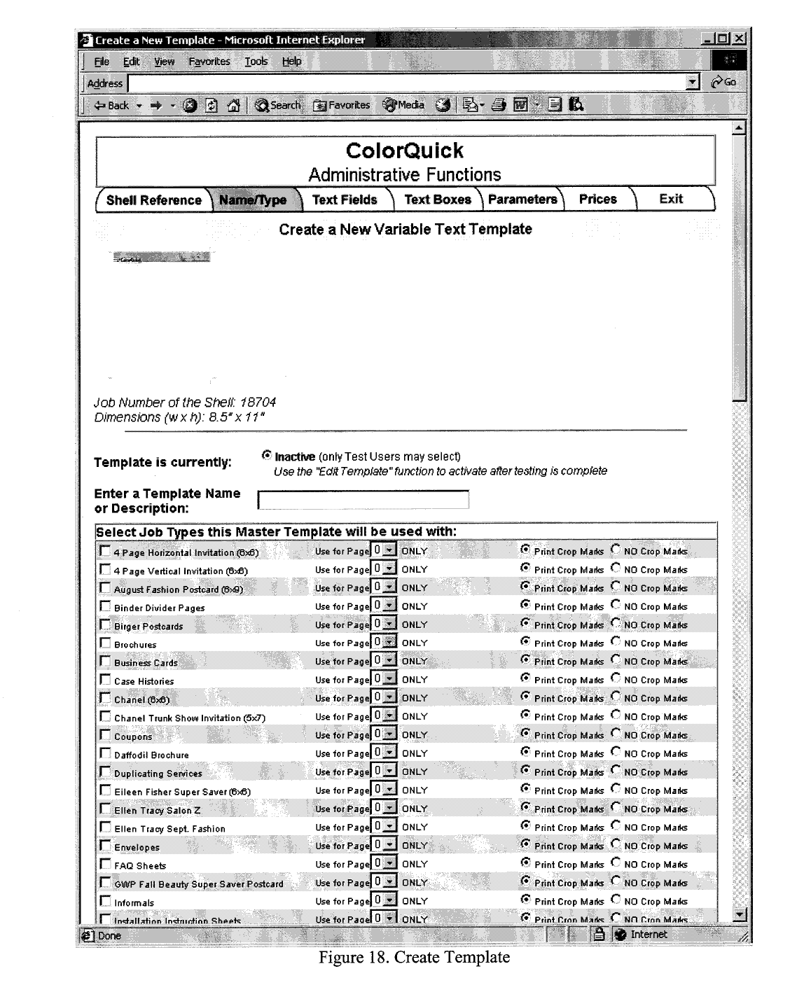

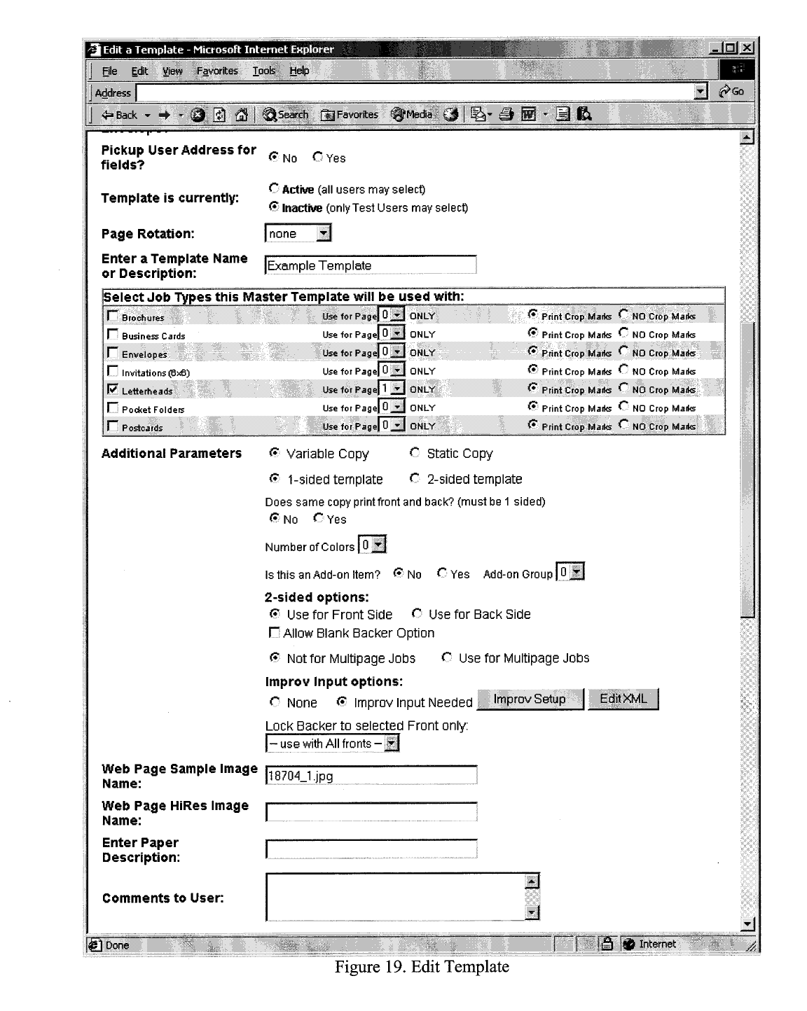

FIGS. 18-19 show pages which allow the user to edit the specifications for the template.

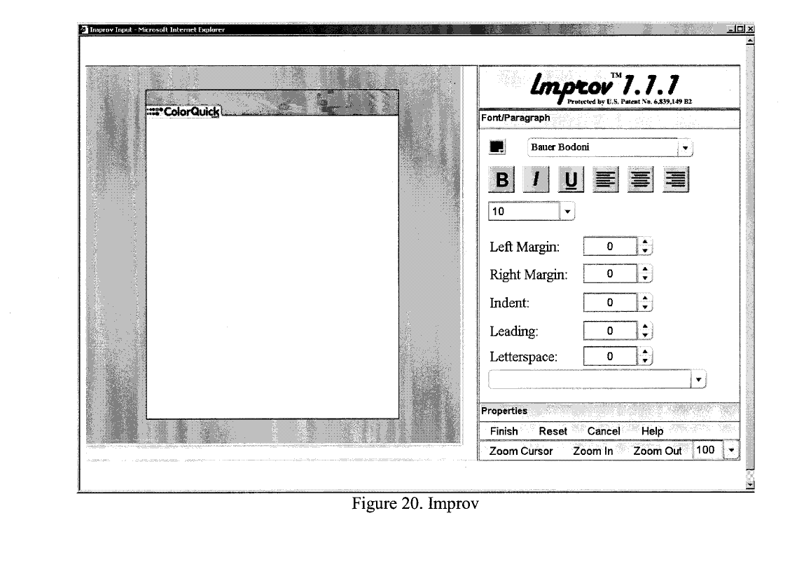

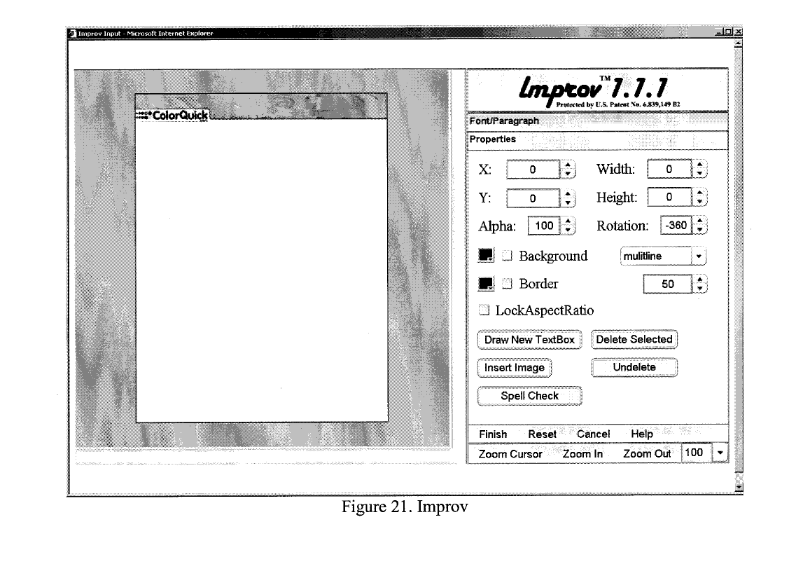

FIGS. 20-21 show the initial state of Improv when it is loaded for the template that is currently being examined. The document on the right side is the same as FIG. 1A.

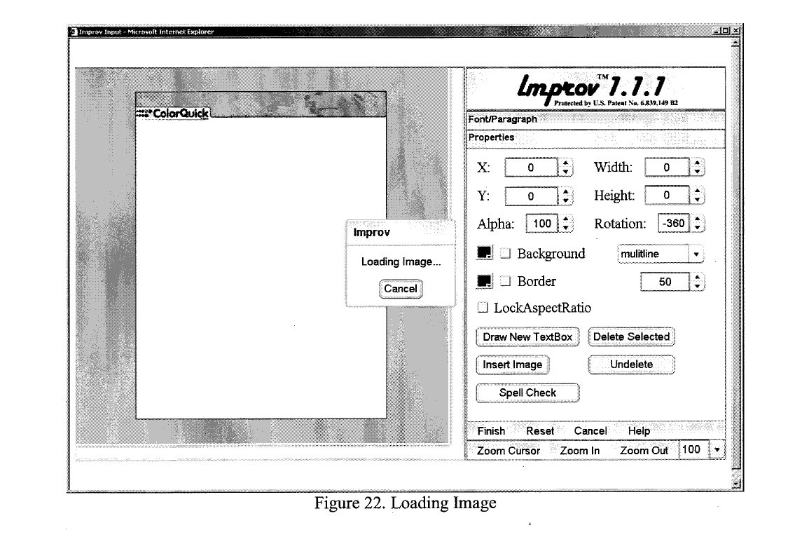

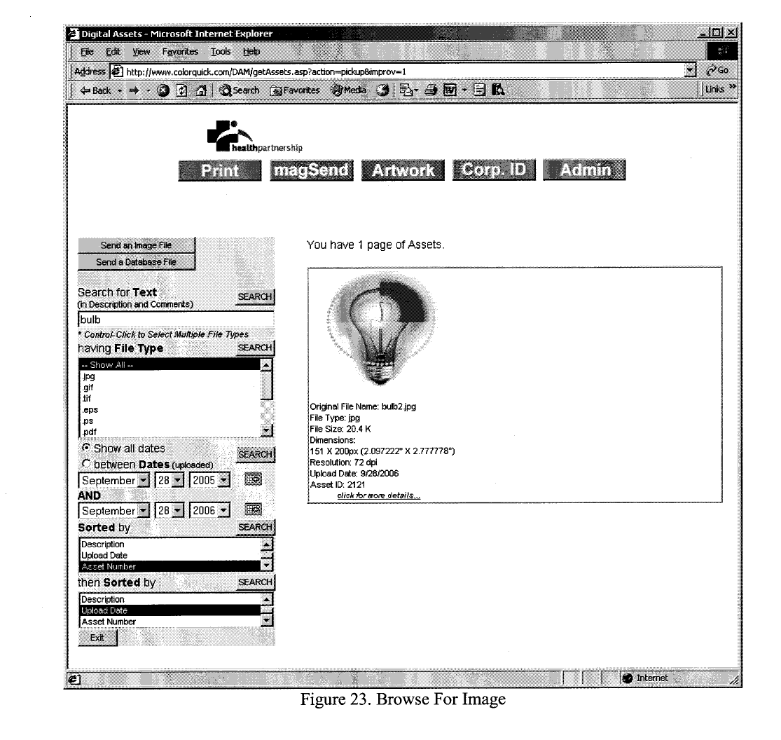

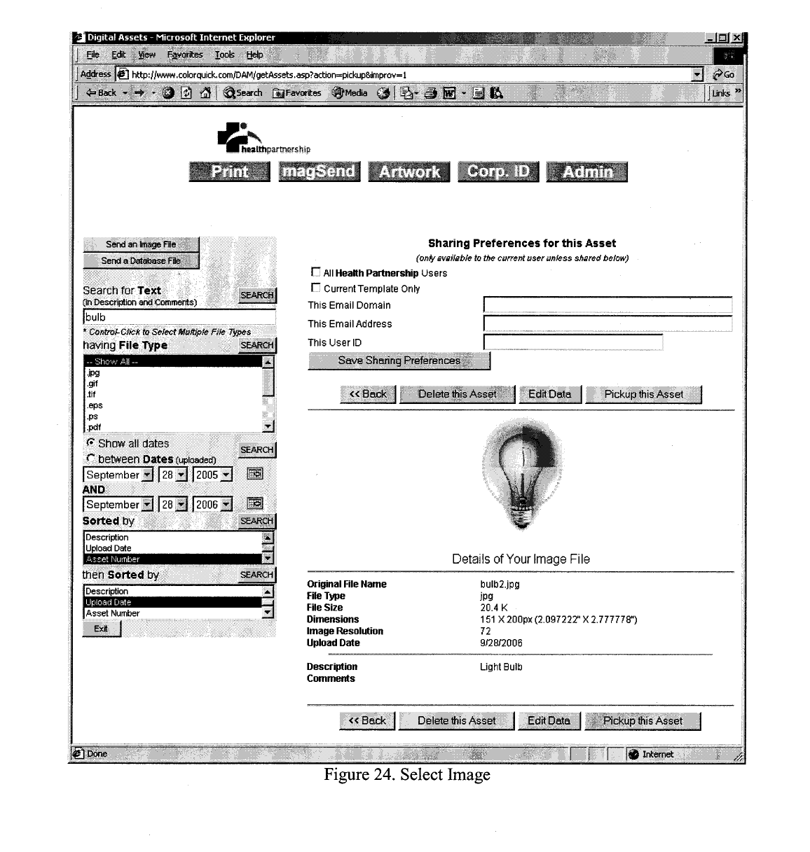

FIG. 22 shows Improv waiting for an image to be selected to be placed on the document. This screen will persist until the user selects and image as show in FIGS. 23-24.

FIGS. 23-24 show how a user may browse for and select an image already uploaded to the server.

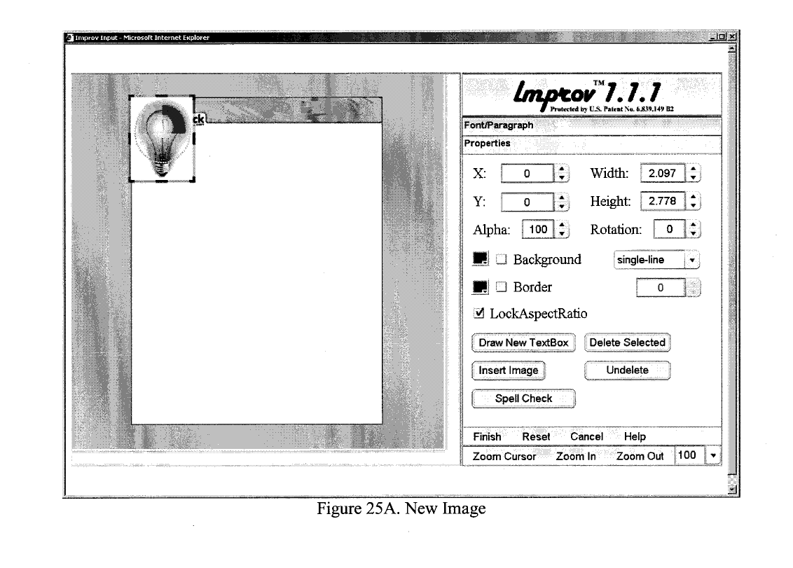

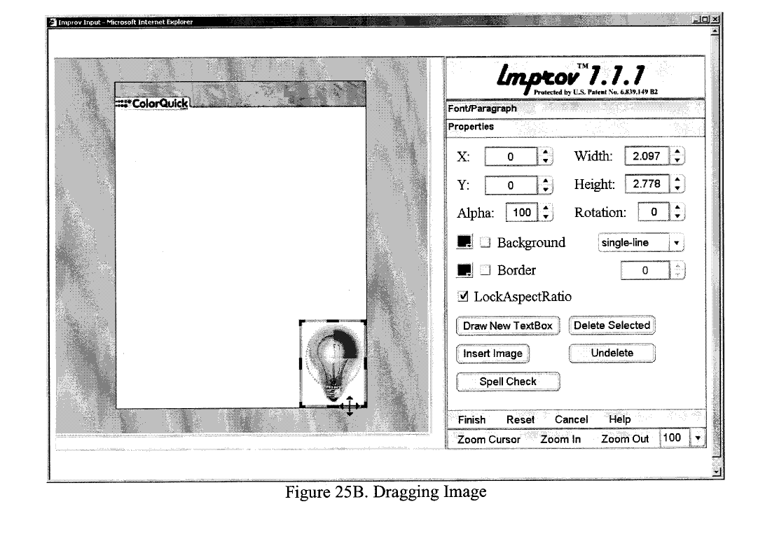

FIG. 25A shows an image loaded onto the document in Improv.

FIG. 25B shows an image being moved within the document using Improv.

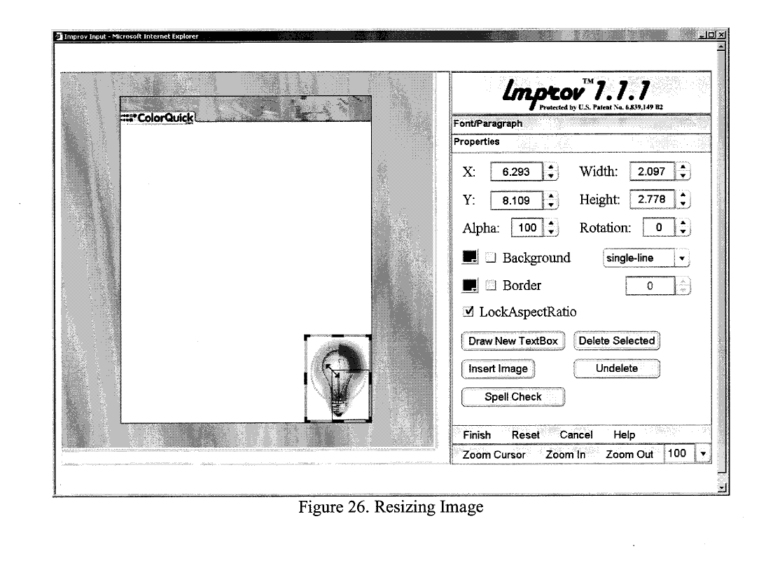

FIG. 26 shows an image being resized within the document using Improv.

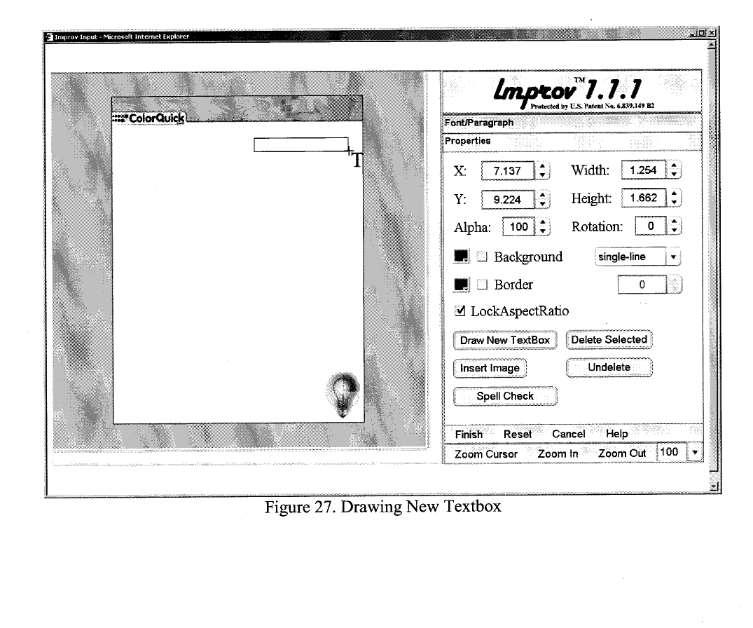

FIG. 27 shows a text box being drawing on the document within Improv.

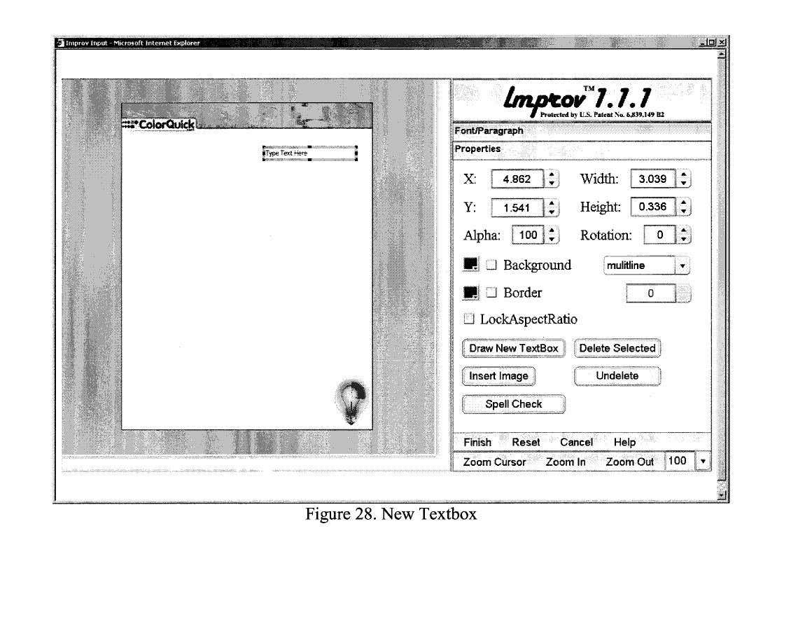

FIG. 28 shows a new text box that had been drawn on the document within Improv.

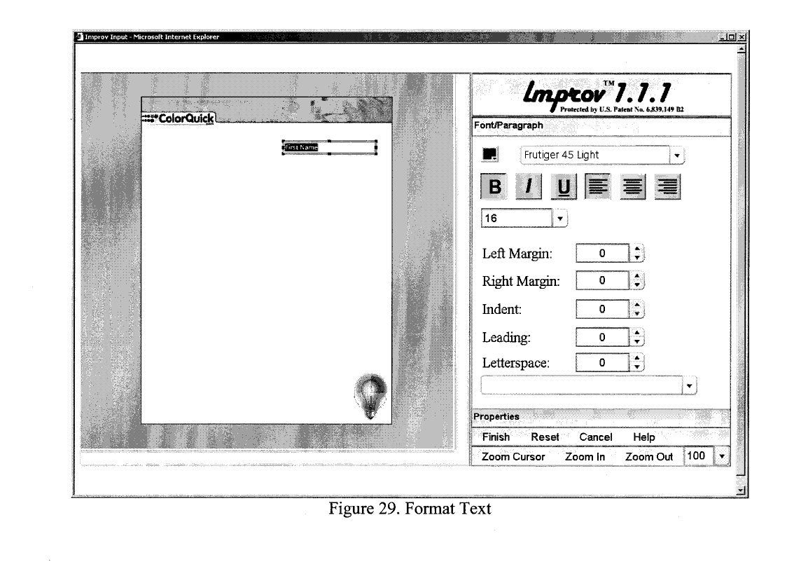

FIG. 29 shows a user editing text which has just been formatted as bold within Improv.

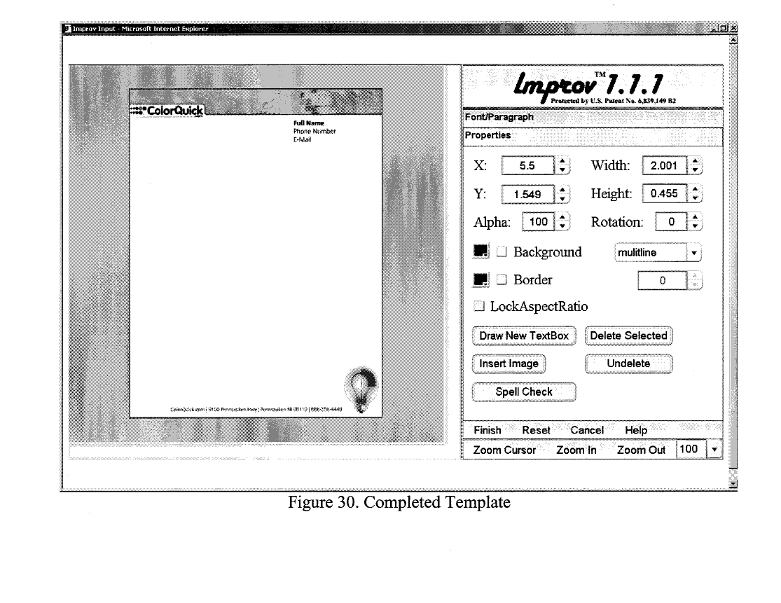

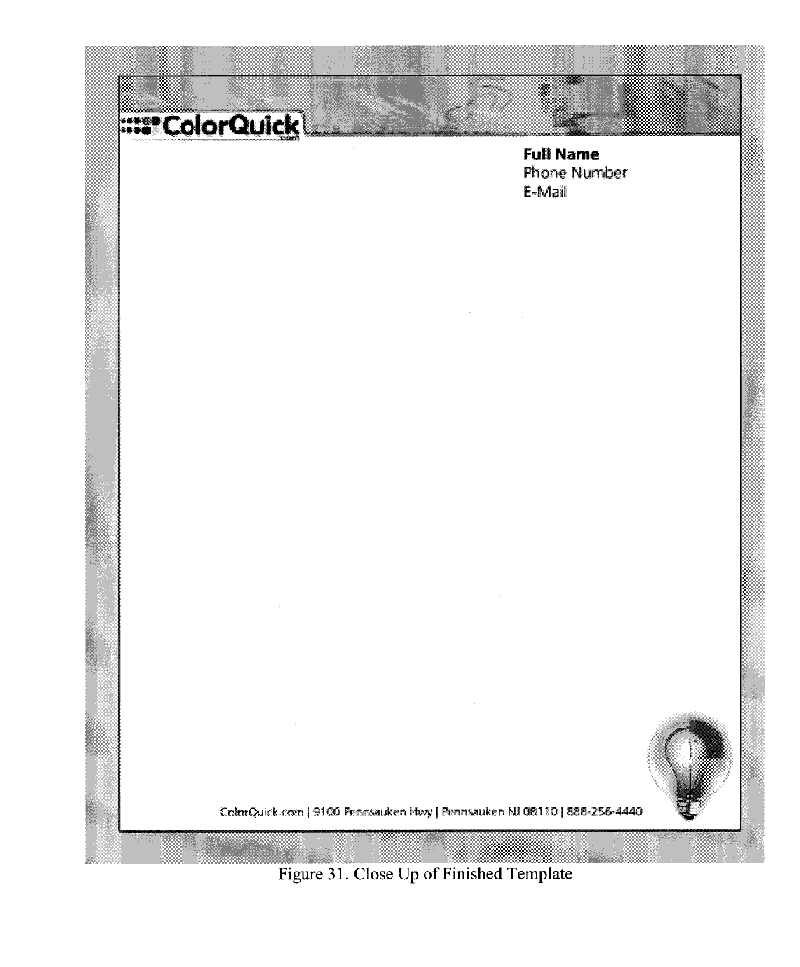

FIGS. 30-31 shows a complete letterhead template created with Improv.

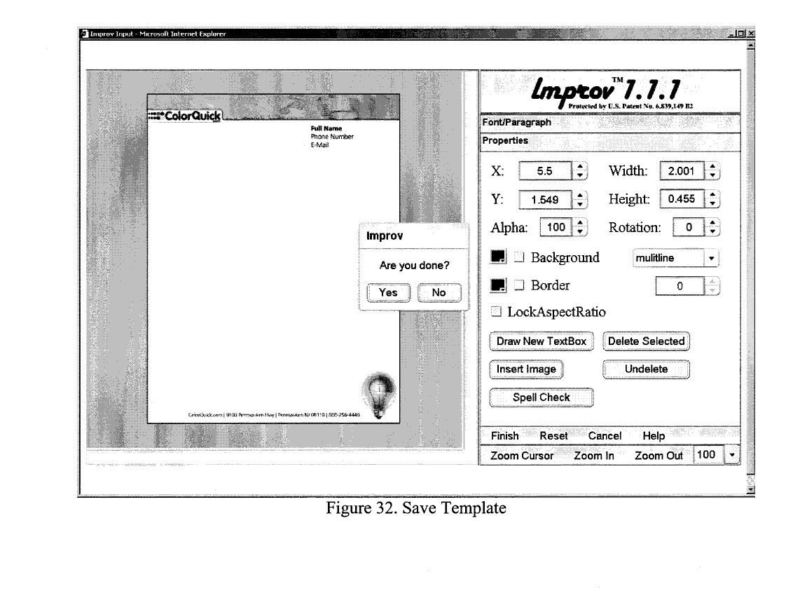

FIG. 32 shows a user saving the template that the user just made in Improv.

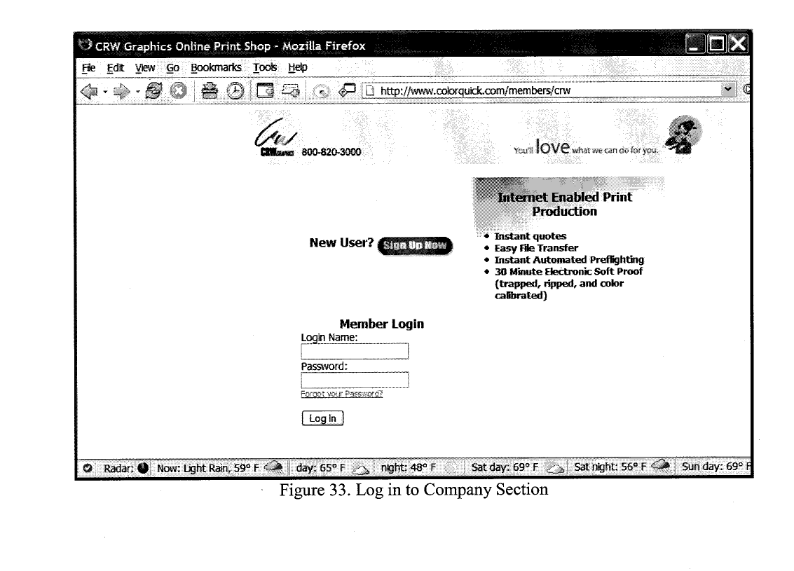

FIG. 33 shows a user logging into ColorQuick.com. The user will be redirected to the section of the site for the company of which they are a member.

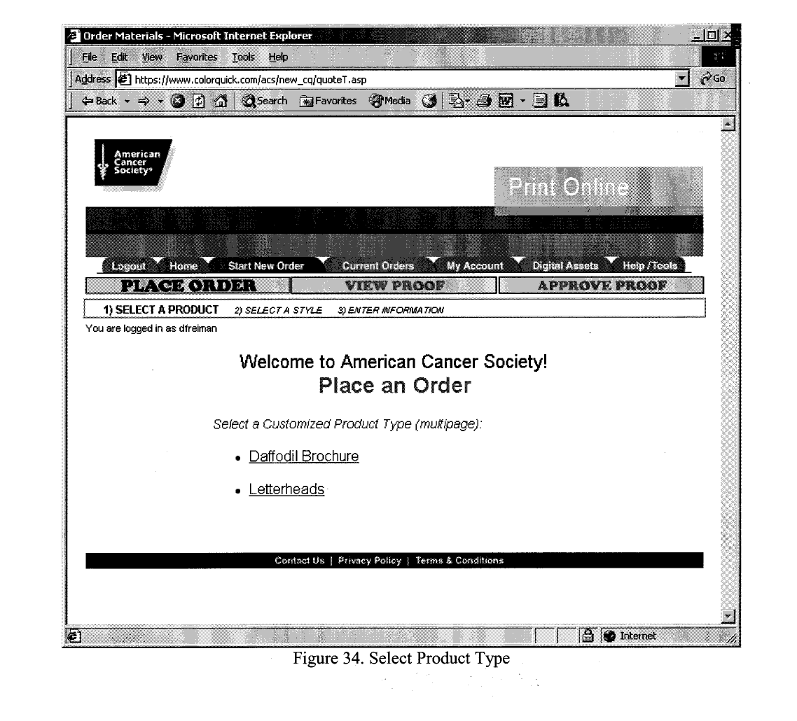

FIG. 34 shows the type of print jobs available to a specific user.

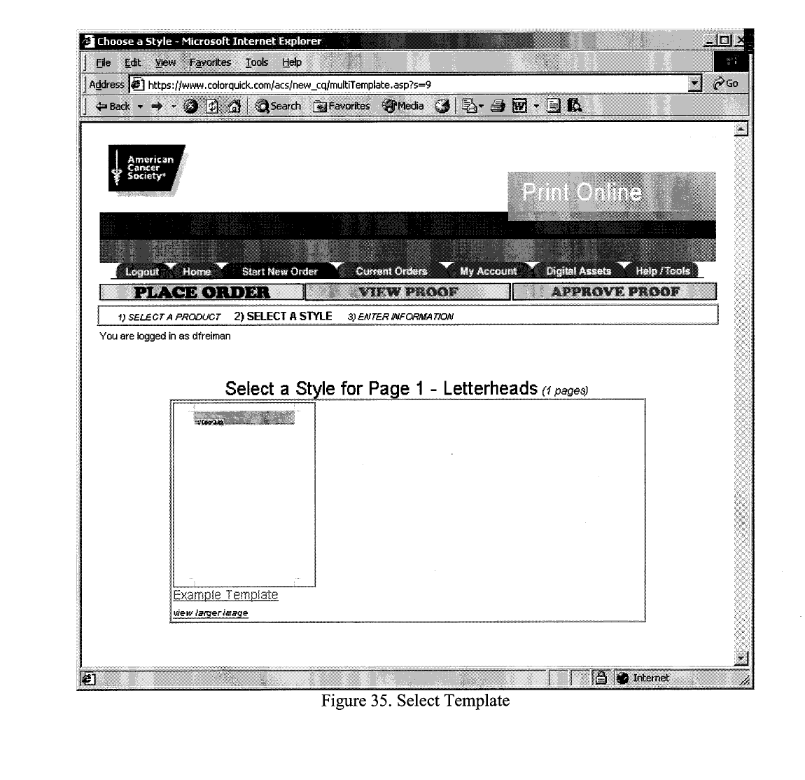

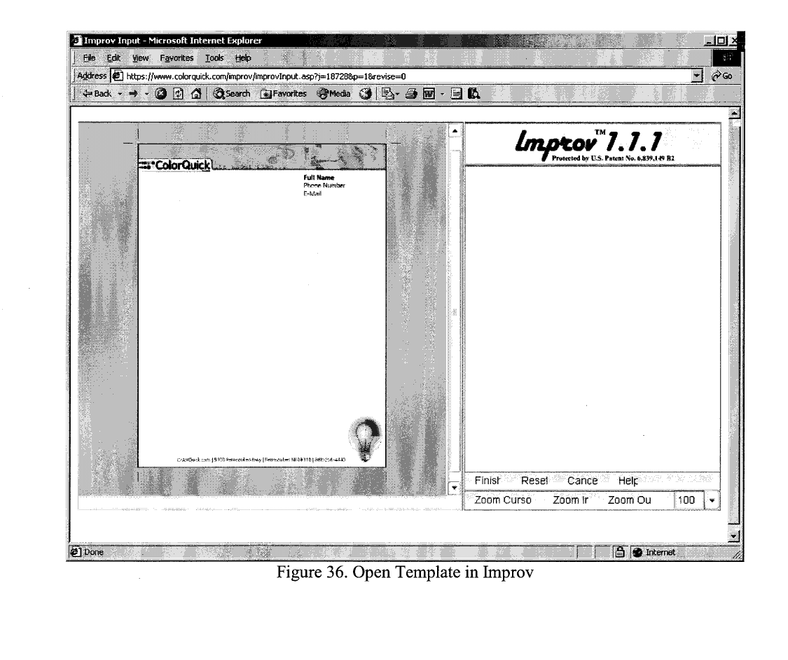

FIG. 35 shows how a user can select a specific template for a specific print job type.

FIG. 36 shows the initial state of Improv when opened by the user. The controls on the right side that appeared in FIGS. 25-32 do not appear in this user interface display screen. However, the document initially appears the same.

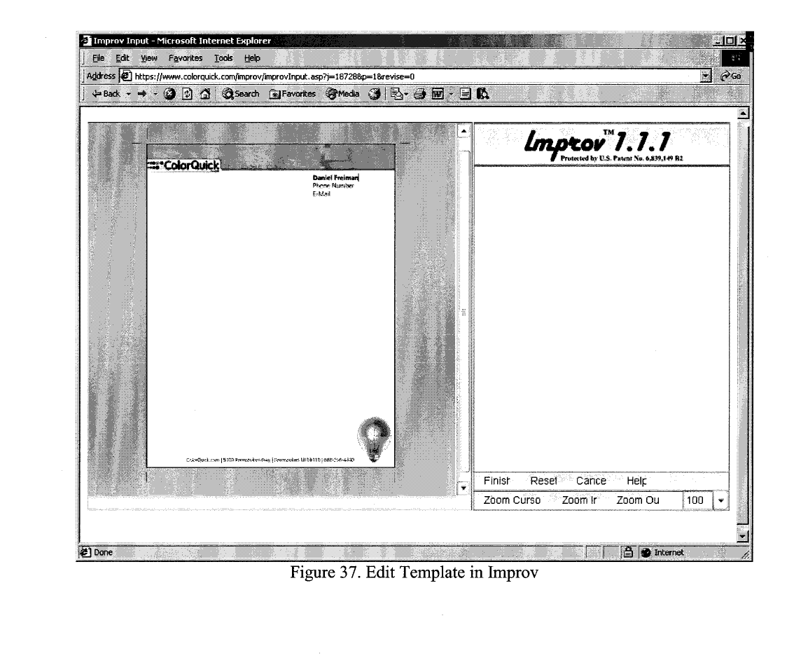

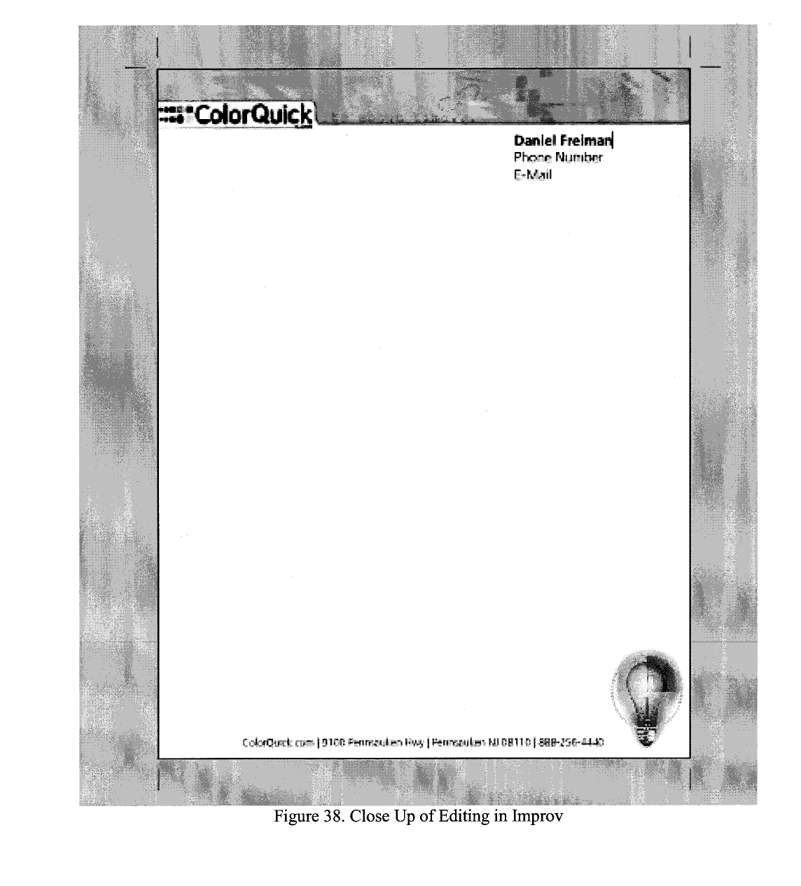

FIGS. 37-38 show a user editing text. The border which allows users to move and resize a text box does not appear when a text box is selected.

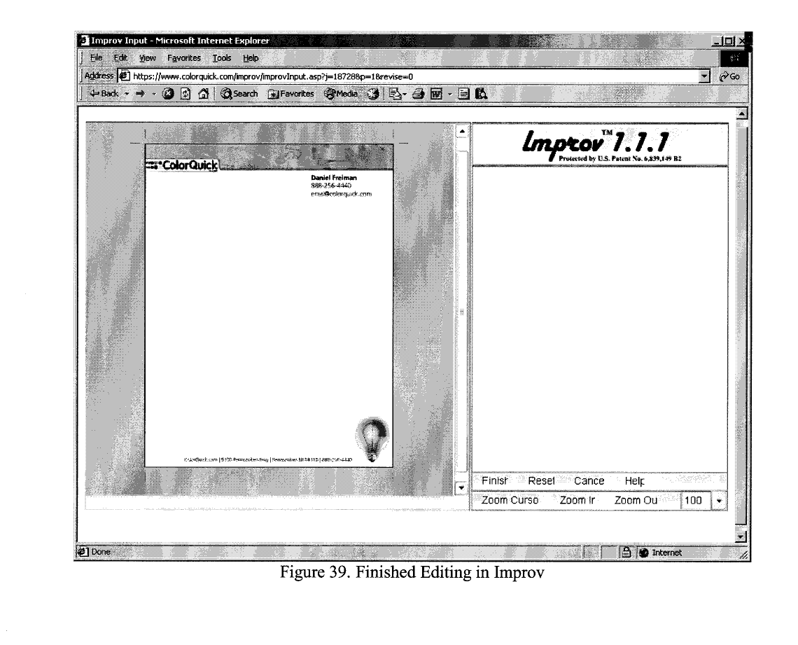

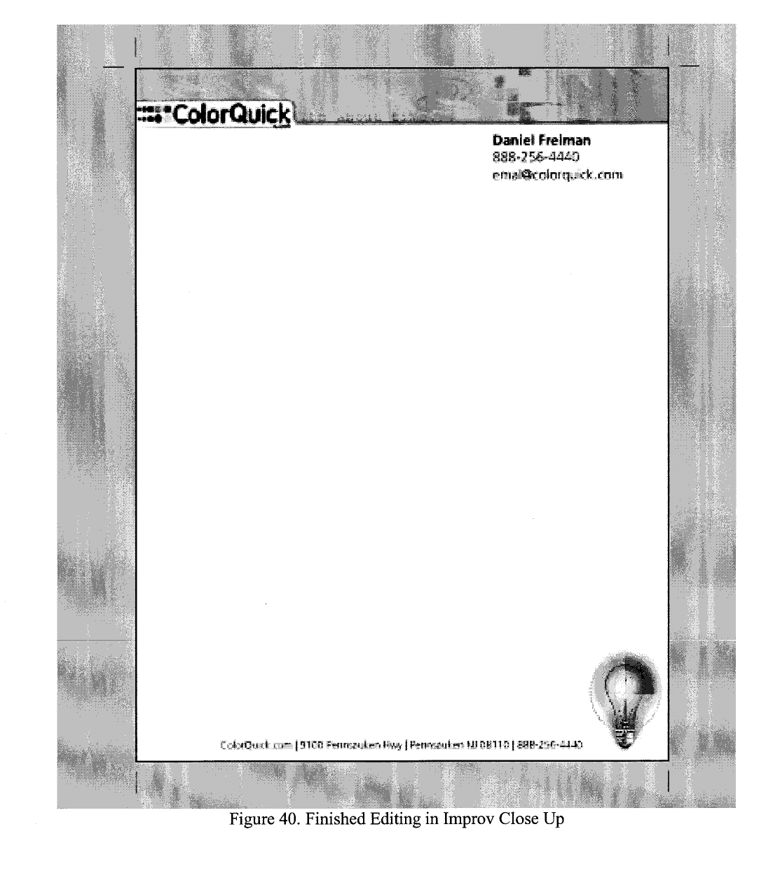

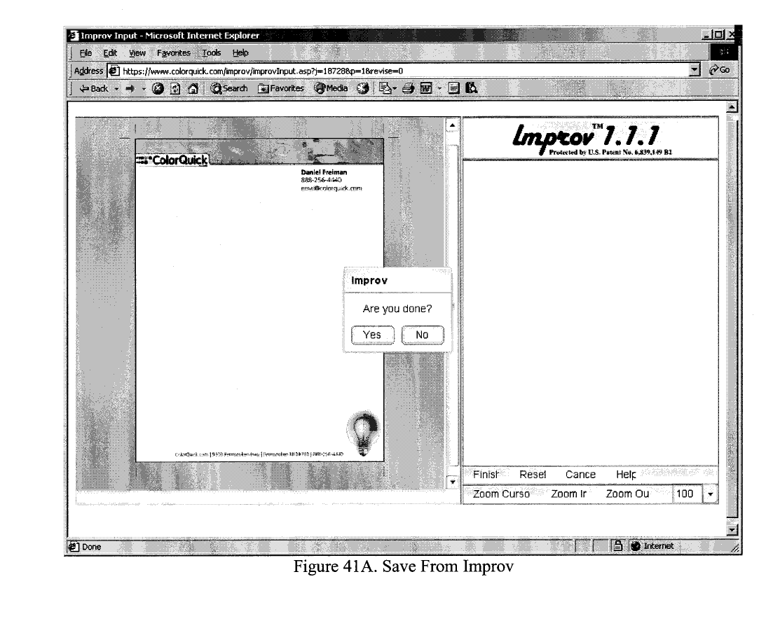

FIG. 39-40 show the finished state of the document.

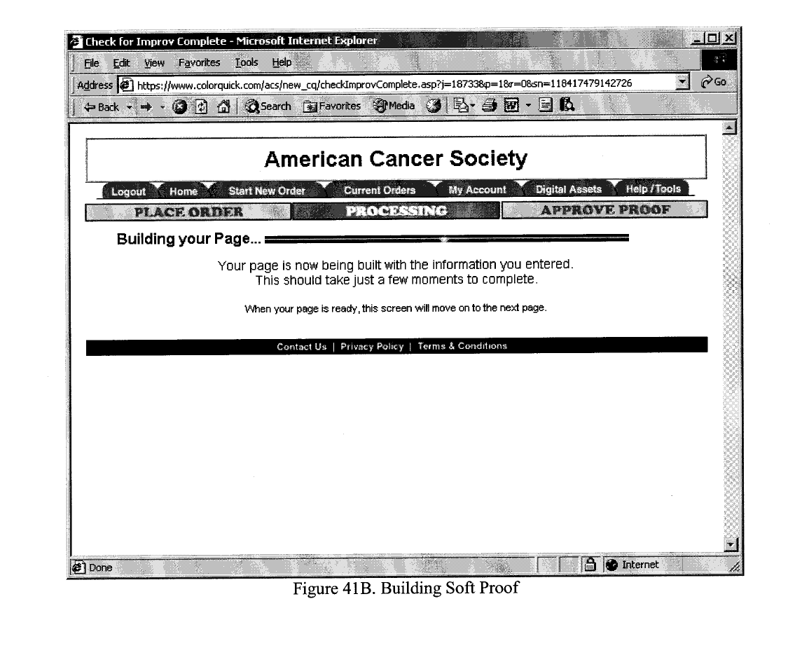

FIG. 41A shows a user saving the alterations made to the document.

FIG. 41B shows a user waiting for the alterations and the additions to document to be committed to the PDF on the server.

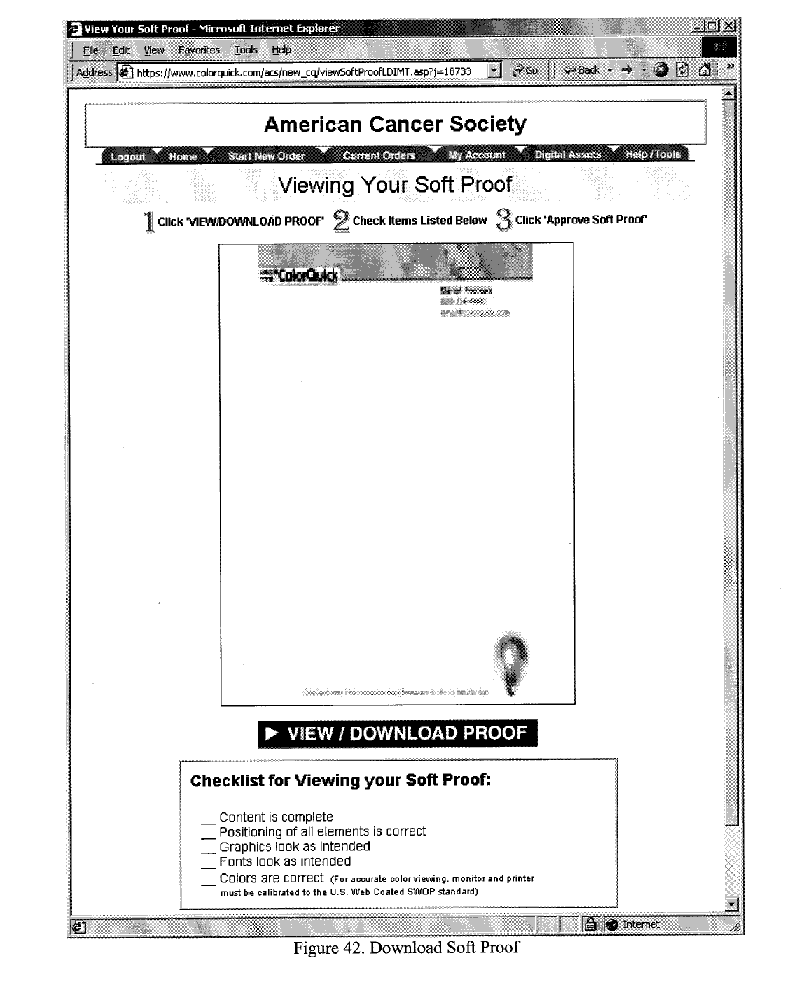

FIG. 42 shows a user previewing the finished print job document.

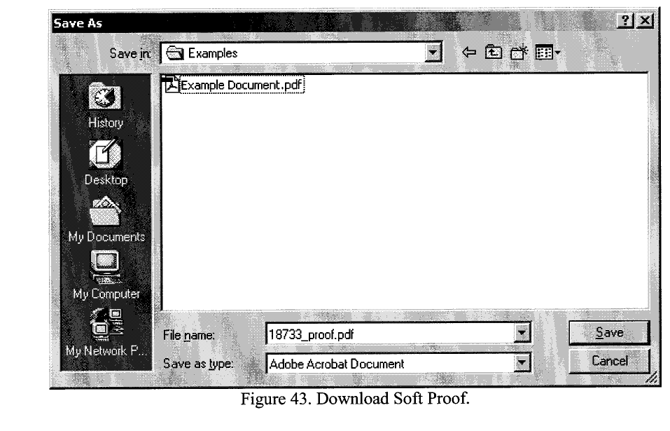

FIG. 43 shows a user selecting where to download the soft proof the print job.

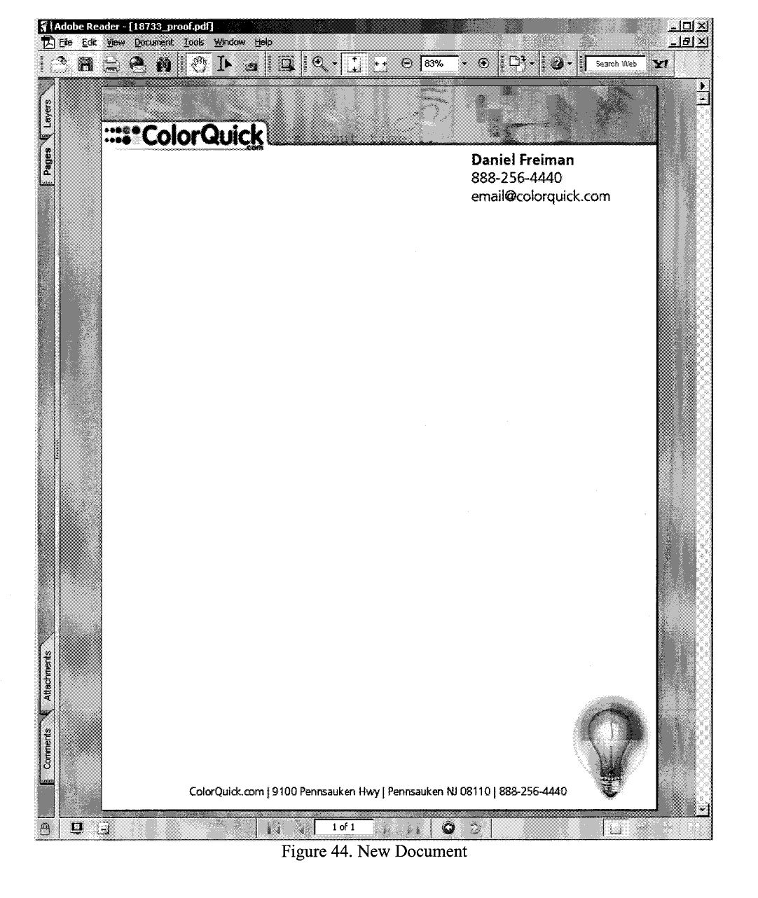

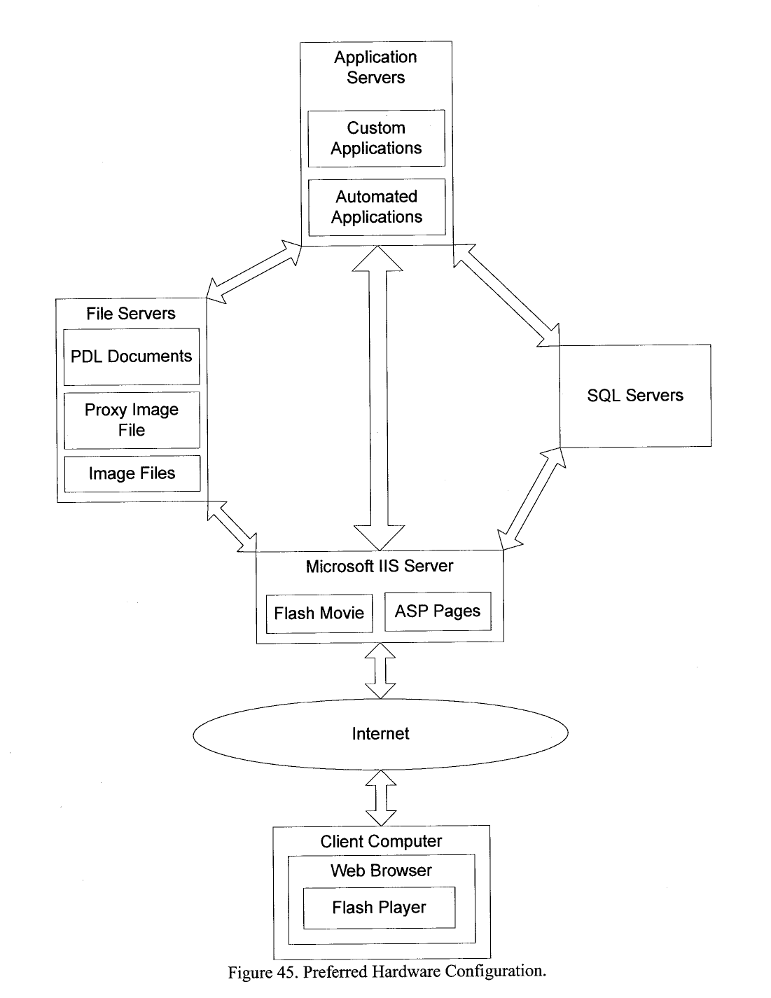

FIG. 44 shows the altered PDF that was downloaded to the user's computer.

FIG. 45 is a diagram of one suitable hardware configuration that may implement the process.

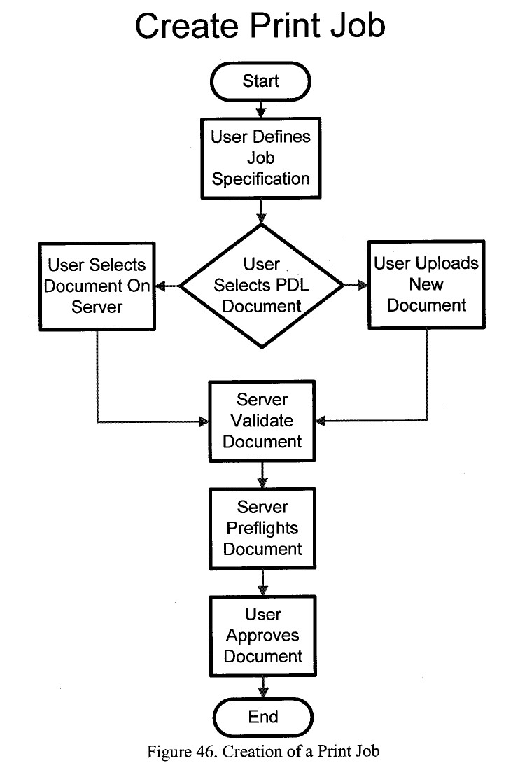

FIG. 46 is a flowchart of the steps to create a finished print job, shown in FIGS. 1A-23.

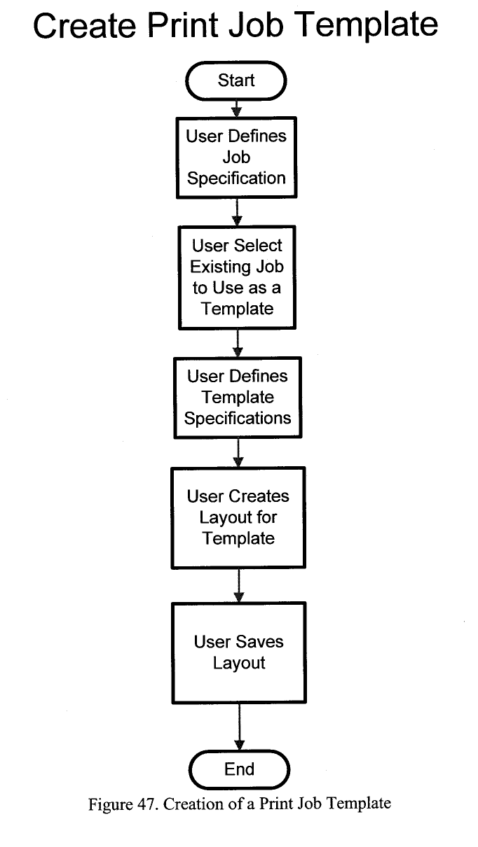

FIG. 47 is a flowchart of the steps to set up a print job template, shown in FIGS. 24-32

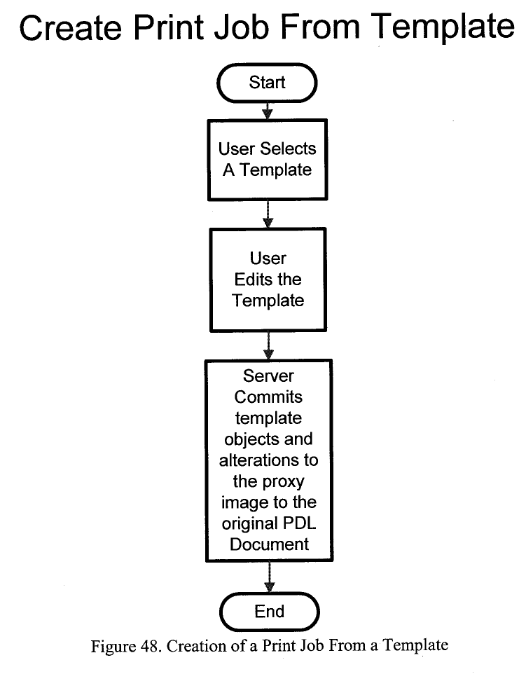

FIG. 48 is a flowchart of the steps to create a print job from a print job template, shown in FIGS. 33-44.

The figures described above show in order an almost complete example of how to use the present invention. The overall steps can be expressed as follows:

1. A user must first create a PDF or PS file (FIG. 1A).

2. They will then log into the site (FIG. 1B).

3. They will then set up the print job (FIGS. 2-4) and then send or select the file to be used for the print job depending upon whether the file needs to be uploaded (FIGS. 5-6) or has already been uploaded (FIGS. 7-8).

4. The server will then preflight the print job (FIG. 9) and the user will be able to view and approve the print job (FIG. 12).

5. The user will access the administrative functions of the website and create a new print job template for a specific company from the print job previously approved (FIGS. 13-17). In an alternative embodiment, a user could create a template job and upload a PDF or PS file directly into the template instead of making the template from an existing job, but the preferred implementation does not do this.

6. The user must then define the properties of this print job template (FIGS. 18-19) and then create and save a layout for the template (FIGS. 20-32).

7. A user, who may be the same or different user than the previous one, logs into the website (FIG. 33) and selects a template that was created (FIGS. 34-35).

8. The user then edits that template layout in Improv (FIGS. 36-41A). In FIGS. 36-41A, the user has no controls with which to alter objects of the template, but a user may have access to some controls if the user setting up the template so desires. This can be accomplished by pressing the EditXML button in FIG. 19 and replacing the appropriate tags in the returned xml file.

9. The user than waits for and then downloads the proof of the print job (FIGS. 41B-42).

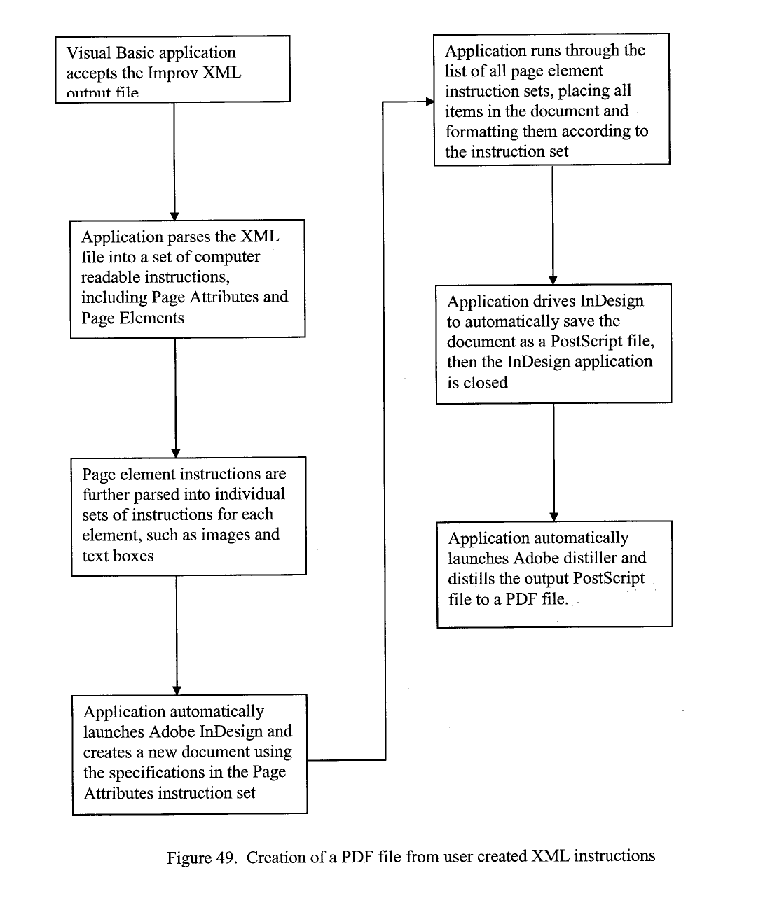

FIG. 49 is a flowchart that shows the prominent steps in the creation of a pdf file from the Improv XML output file. The Visual Basic application accepts an XML file to start the process. That file is then parsed into a set of instructions which are used to drive Adobe® InDesign® to create a document to the specified size. The XML data is further parsed into instruction sets for each individual page element. These include images and text boxes. Instructions for each element are parsed and associated with that element, such as position, size, masking, opacity amount, colorspace, font name, font attributes (bold, italic, underline), font size, orientation, kerning, letter spacing, alignment, and the like. Once the new document is created, the application runs through all the instruction sets automatically, thereby building the document in InDesign. Once all of the page elements have been laid out in the document, the application drives InDesign to save the document as a PostScript file. InDesign automatically shuts down once the file has been saved. The application then automatically launches Adobe Distiller and distills the file to a PDF file.

In preferred embodiments described above, the properties of the inserted graphical objects are stored in XML. However, in alternative embodiments, the properties of the inserted graphical objects may be stored in data formats other than XML, such as JavaScript Object Notation (JSON).

In the preferred embodiment described above, the PDL file (e.g., PDF file) from which the still image proxy was created is “rebuilt” using Adobe InDesign and Acrobat to reflect the modifications made to the image display of the still image proxy, including the added or modified graphical objects. However, in alternate embodiments, the PDL file may be “revised” and/or rebuilt to best meet print production requirements, and to match the modifications made by the user to the still image proxy, including the added or modified graphical objects.

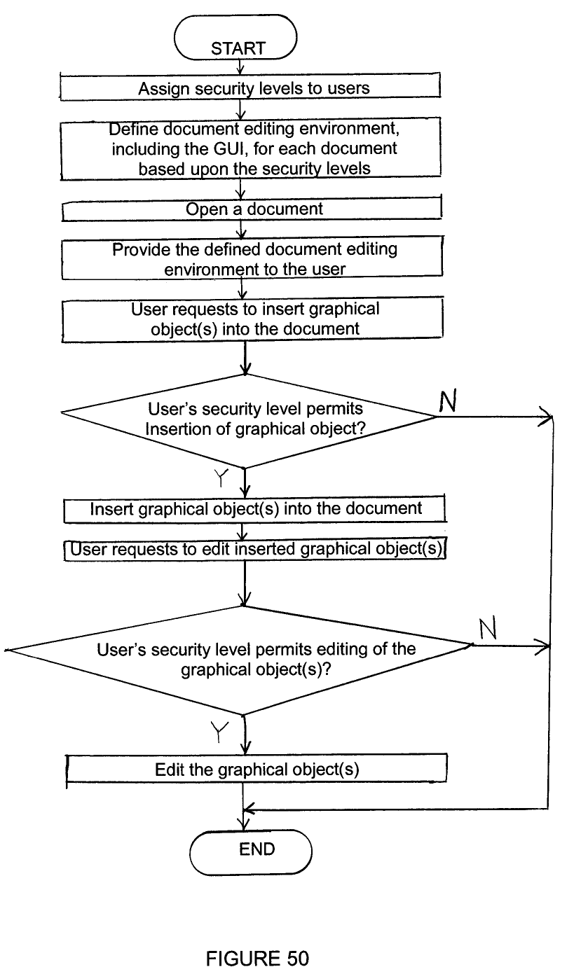

FIG. 50 is a self-explanatory flowchart of a preferred embodiment for using a security level of a user to set a document editing environment for a document. As shown in the flowchart, whether a graphical object is even permitted to be inserted into a document, and the types of permissible edits if insertion is permitted, may also be controlled by the security level. A similar security level process may be used to control whether conventional manipulations as described in U.S. Pat. No. 6,839,149 are permitted to be made to an image display of a still image proxy, and if so, the type of permissible manipulations.

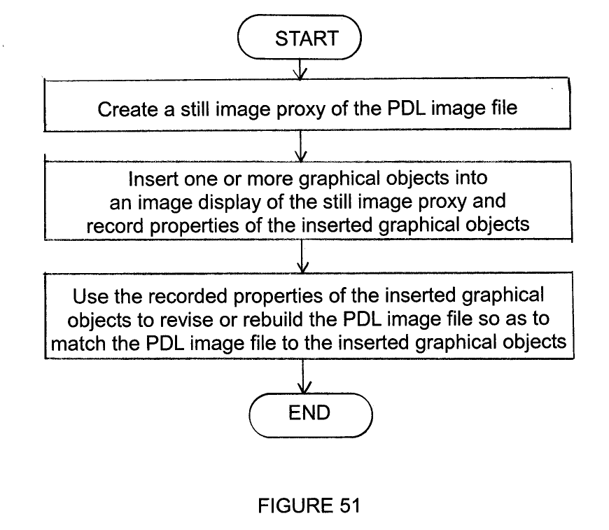

FIG. 51 is a self-explanatory flowchart of a preferred embodiment for inserting graphical objects into a still image proxy of a PDL image file during preparation of production data.

One preferred embodiment of the present invention is implemented via the source code in the accompanying Appendix. Part I of the Appendix source code is the main source code for implementing Improv. The source code also includes an example input file for Improv. Part II of the Appendix source code is related to the process shown in FIG. 49. However, the scope of the present invention is not limited to this particular implementation of the invention.

The website surrounding Improv is a standard ecommerce design with users and products with properties.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

While the present invention has been particularly shown and described with reference to one preferred embodiment thereof, it will be understood by those skilled in the art that various alterations in form and detail may be made therein without departing from the spirit and scope of the present invention.

What is claimed is:

1. A computer-implemented method of providing a document editing environment that varies based on the type of user, the method comprising:
(a) assigning one of a plurality of different types of security levels to different users who edit documents;
(b) defining a document editing environment for a plurality of different types of documents, each document editing environment being defined based at least upon the security level assigned to a user who edits the document; and
(c) providing the defined document editing environment to the user for use in editing a document.

2. The method of claim 1 wherein the document editing environment includes a graphical user interface (GUI), and step (b) further comprises varying the GUI based at least upon the security level of the user who edits the document.

3. The method of claim 1 wherein each of the plurality of different types of documents has a plurality of different document editing environments, and step (b) further comprises defining the document editing environment based upon the security level assigned to a user who edits the document and the type of document.

4. The method claim 1 further comprises:
(d) providing one or more graphical objects in the document, wherein step (c) further comprises prohibiting users who have predetermined security levels from editing the graphical objects.

5. The method claim 1 wherein the document editing environment further comprises an image display of a still image proxy of an electronic document, the method further comprising:
(d) providing one or more graphical objects in the document, wherein step (c) further comprises prohibiting users who have predetermined security levels from making selected edits to the graphical objects.

6. The method of claim 1 further comprising:
(d) providing one or more graphical objects that are insertable into the document, wherein step
(c) further comprises prohibiting users who have predetermined security levels from inserting the graphical objects.

7. The method claim 1 wherein the document editing environment further comprises an image display of a still image proxy of an electronic document that can be manipulated by users, and step (c) further comprises prohibiting users who have predetermined security levels from making selected manipulations to the electronic document.

8. A computer-implemented apparatus for providing a document editing environment that varies based on the type of user, the apparatus comprising:
(a) means for assigning one of a plurality of different types of security levels to different users who edit documents;
(b) means for defining a document editing environment for a plurality of different types of documents, each document editing environment being defined based at least upon the security level assigned to a user who edits the document; and
(c) means for providing the defined document editing environment to the user for use in editing a document.

9. The apparatus of claim 8 wherein the document editing environment includes a graphical user interface (GUI), and the means for defining a document editing environment further comprises means for varying the GUI based at least upon the security level of the user who edits the document.

10. The apparatus of claim 8 wherein each of the plurality of different types of documents has a plurality of different document editing environments, and the means for defining a document editing environment further defines the document editing environment based upon the security level assigned to a user who edits the document and the type of document.

11. The apparatus claim 8 further comprises:
(d) means for providing one or more graphical objects in the document, wherein the means for providing the defined document editing environment further comprises means for prohibiting users who have predetermined security levels from editing the graphical objects.

12. The apparatus of claim 8 wherein the document editing environment further comprises an image display of a still image proxy of an electronic document, the apparatus further comprising:
(d) means for providing one or more graphical objects in the document, wherein the means for providing the defined document editing environment further prohibits users who have predetermined security levels from making selected edits to the graphical objects.

13. The apparatus of claim 8 further comprising:
(d) means for providing one or more graphical objects that are insertable into the document, wherein the means for providing the defined document editing environment further comprises prohibiting users who have predetermined security levels from inserting the graphical objects.

14. The apparatus claim 8 wherein the document editing environment further comprises an image display of a still image proxy of an electronic document that can be manipulated by users, and the means for providing the defined document editing environment further comprises prohibiting users who have predetermined security levels from making selected manipulations to the electronic document.

15. An article of manufacture for providing a document editing environment that varies based on the type of user, the article of manufacture comprising a computer-readable medium encoded with computer-executable instructions for performing a method comprising:
(a) assigning one of a plurality of different types of security levels to different users who edit documents;
(b) defining a document editing environment for a plurality of different types of documents, each document editing environment being defined based at least upon the security level assigned to a user who edits the document; and
(c) providing the defined document editing environment to the user for use in editing a document.

16. The article of manufacture of claim 15 wherein the document editing environment includes a graphical user interface (GUI), and step (b) further comprises varying the GUI based at least upon the security level of the user who edits the document.

17. The article of manufacture of claim 15 wherein each of the plurality of different types of documents has a plurality of different document editing environments, and step (b) further comprises defining the document editing environment based upon the security level assigned to a user who edits the document and the type of document.

18. The article of manufacture of claim 15 wherein the computer-executable instructions perform a method further comprising:
(d) providing one or more graphical objects in the document, wherein step (c) further comprises prohibiting users who have predetermined security levels from editing the graphical objects.

19. The article of manufacture of claim 15 wherein the document editing environment further comprises an image display of a still image proxy of an electronic document, wherein the computer-executable instructions perform a method further comprising:
(d) providing one or more graphical objects in the document, wherein step (c) further comprises prohibiting users who have predetermined security levels from making selected edits to the graphical objects.

20. The article of manufacture of claim 15 wherein the computer-executable instructions perform a method further comprising:
(d) providing one or more graphical objects that are insertable into the document, wherein step
(c) further comprises prohibiting users who have predetermined security levels from inserting the graphical objects.

21. The article of manufacture of claim 15 wherein the document editing environment further comprises an image display of a still image proxy of an electronic document that can be manipulated by users, and step (c) further comprises prohibiting users who have predetermined security levels from making selected manipulations to the electronic document.
